(19) United States
(12) Patent Application Publication
(10) Pub. No.: US 2026/0034814 A1
(43) Pub. Date: Feb. 5, 2026

(54) LIQUID DISCHARGE HEAD UNIT AND LIQUID DISCHARGE APPARATUS

(71) Applicant: Kentaro UEHARA, Kanagawa (JP)

(72) Inventor: Kentaro UEHARA, Kanagawa (JP)

(21) Appl. No.: 19/271,840

(22) Filed: Jul. 17, 2025

(30) Foreign Application Priority Data
Jul. 30, 2024 (JP) 2024-123376
Mar. 19, 2025 (JP) 2025-044875
Mar. 27, 2025 (JP) 2025-053666

(51) Int. Cl. B41J 25/308

(52) U.S. Cl. CPC B41J 25/3086

(57) ABSTRACT

A liquid discharge head unit includes: a liquid discharge head to discharge a liquid in a discharge direction; a support supporting the liquid discharge head; and a coupler to couple the liquid discharge head to the support. The support has an opening into which at least a discharge side of the liquid discharge head is insertable in the discharge direction, the coupler includes: a first contact contacting the liquid discharge head inserted into the opening; and a second contact contacting the support, and the first contact and the second contact are disposed at different positions in the discharge direction.

### CROSS-REFERENCE TO RELATED APPLICATIONS

This patent application is based on and claims priority pursuant to 35 U.S.C. § 119 (a) to Japanese Patent Application No. 2024-123376, filed on Jul. 30, 2024, Japanese Patent Application No. 2025-044875, filed on Mar. 19, 2025, and Japanese Patent Application No. 2025-053666, filed on Mar. 27, 2025, in the Japan Patent Office, the entire disclosure of each of which is hereby incorporated by reference herein.

### BACKGROUND

### Technical Field

Aspects of the present disclosure relate to a liquid discharge head unit and a liquid discharge apparatus.

### Related Art

Examples of a liquid discharge apparatus that discharges liquid includes an inkjet image forming apparatus that discharges liquid ink onto a sheet, such as a paper sheet, to form an image.

The image forming apparatus includes a liquid discharge head that discharges ink onto a sheet. A height adjusting mechanism for adjusting the height of the liquid discharge head is provided so as to adjust a distance between the sheet and the liquid discharge head.

However, when the height of the liquid discharge head needs to be adjusted beyond a preset adjustment range, an existing height adjusting mechanism cannot cope with such a height adjustment. Therefore, it is necessary to significantly change the shape of the liquid discharge head or the shape of a support supporting the liquid discharge head. This may force a significant design change.

### SUMMARY

The present disclosure provides a liquid discharge head unit including: a liquid discharge head to discharge a liquid in a discharge direction; a support supporting the liquid discharge head; and a coupler to couple the liquid discharge head to the support. The support has an opening into which at least a discharge side of the liquid discharge head is insertable in the discharge direction, the coupler includes: a first contact contacting the liquid discharge head inserted into the opening; and a second contact contacting the support, and the first contact and the second contact are disposed at different positions in the discharge direction.

The present disclosure further provides a liquid discharge head unit including: a liquid discharge head having a nozzle face having nozzles to discharge a liquid in a discharge direction; a support supporting the liquid discharge head; a coupler to couple the liquid discharge head to the support; and a height adjuster. The support has an opening into which at least a discharge side of the liquid discharge head is insertable in the discharge direction, the height adjuster has a first inclined surface inclined relative to the nozzle face, the height adjuster is interposed between at least one of: the coupler and the liquid discharge head in the discharge direction; or the coupler and the support in the discharge direction, the coupler has a second inclined surface contacting the first inclined surface of the height adjuster, and the height adjuster is movable in a longitudinal direction, orthogonal to the discharge direction, parallel to the nozzle face to adjust a height of the liquid discharge head.

The present disclosure further provides a liquid discharge head unit including: a liquid discharge head having a nozzle face having nozzles to discharge a liquid in a discharge direction; a support supporting the liquid discharge head; and a height adjuster disposed between the liquid discharge head and the support. The support has an opening into which at least a discharge side of the liquid discharge head is insertable in the discharge direction, at least one of the liquid discharge head and the support has a first inclined surface inclined relative to the nozzle face, the height adjuster has a second inclined surface in contact with the second inclined surface of the at least one of the liquid discharge head and the support, and the height adjuster is movable in a longitudinal direction, orthogonal to the discharge direction and intersecting the second inclined surface.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a general arrangement of an image forming apparatus according to a first embodiment of the present disclosure;

FIG. 2 is a control block diagram of the image forming apparatus according to the first embodiment;

FIG. 3 is an external perspective view of a liquid discharge head according to the first embodiment;

FIG. 4 is a cross-sectional view of the liquid discharge head according to the first embodiment;

FIG. 5 is an external perspective view of a liquid discharge head unit according to the first embodiment;

FIG. 6 is a plan view of the liquid discharge head unit according to the first embodiment;

FIG. 7 is a cross-sectional view of the liquid discharge head unit according to the first embodiment;

FIG. 8 illustrates an exemplary height adjustment in the first embodiment;

FIG. 9 illustrates an exemplary height adjustment to be performed by means of height adjusters;

FIG. 10 illustrates another exemplary height adjustment to be performed by means of the height adjusters;

FIG. 11 is a cross-sectional view of a liquid discharge head unit according to a second embodiment;

FIG. 12 illustrates an exemplary height adjustment in the second embodiment;

FIG. 13 illustrates an exemplary height adjustment to be performed by means of height adjusters;

FIG. 14 illustrates another exemplary height adjustment to be performed by means of the height adjusters;

FIG. 15 is a diagram illustrating an exemplary inclination adjustment in the first embodiment;

FIG. 16 is a diagram illustrating an exemplary inclination adjustment in the second embodiment;

FIG. 17 is a diagram illustrating an exemplary inclination adjustment to be performed by means of the height adjusters;

FIG. 18 is a diagram illustrating another exemplary inclination adjustment to be performed by means of the height adjuster;

FIG. 19 is a diagram illustrating still another exemplary inclination adjustment to be performed by means of the height adjuster;

FIG. 20 is a plan view of supports that support multiple liquid discharge heads, which illustrates an exemplary arrangement of the supports;

FIG. 21 is a diagram illustrating an exemplary height adjustment to be performed when a sheet is conveyed horizontally;

FIG. 22 is a diagram illustrating an exemplary height adjustment to be performed when a sheet is conveyed in an arc-like manner;

FIG. 23 is a diagram illustrating an exemplary height adjustment between an upstream side and a downstream side, to be performed by coupler having different height differences between contacts;

FIG. 24 is a diagram illustrating an exemplary height adjustment between the upstream side and the downstream side, to be performed by means of the height adjusters;

FIG. 25 is an external perspective view of a liquid discharge head unit according to a third embodiment;

FIG. 26 is a plan view of the liquid discharge head unit according to the third embodiment;

FIG. 27 is a cross-sectional view of the liquid discharge head unit according to the third embodiment;

FIG. 28 is a diagram illustrating an exemplary height adjustment in the third embodiment;

FIG. 29 is a diagram illustrating another exemplary height adjustment in the third embodiment;

FIG. 30 is a diagram for describing functions of recesses provided in height adjusters according to the third embodiment;

FIG. 31 is a cross-sectional view of a liquid discharge head unit according to a fourth embodiment;

FIG. 32 is a diagram illustrating an exemplary height adjustment in the fourth embodiment;

FIG. 33 is a diagram illustrating another exemplary height adjustment in the fourth embodiment;

FIG. 34 is a cross-sectional view of a liquid discharge head unit according to a fifth embodiment;

FIG. 35 is a diagram illustrating an exemplary height adjustment in the fifth embodiment;

FIG. 36 is a diagram illustrating another exemplary height adjustment in the fifth embodiment;

FIG. 37 is a plan view of a modification of the height adjuster;

FIG. 38 is a plan view of another modification of the height adjuster;

FIG. 39 is a cross-sectional view of another modification of the height adjuster taken along line M-M in FIG. 38;

FIG. 40 is a plan view of still another modification of the height adjuster;

FIG. 41 is a cross-sectional view of the still another modification of the height adjuster taken along line N-N in FIG. 40;

FIG. 42 is a diagram illustrating a state in which an engagement protrusion of a coupler and an engagement recess of a height adjuster are engaged with each other;

FIG. 43 is a diagram illustrating an exemplary electrode manufacturing apparatus to which the present disclosure can be applied;

FIG. 44 is a diagram illustrating a configuration of a liquid discharge head unit according to a comparative example; and

FIG. 45 is a reference diagram illustrating a state in which a nozzle face is inclined with respect to a sheet.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present disclosure will be described with reference to the accompanying drawings. Referring now to the drawings, wherein like reference numerals designate identical or corresponding parts throughout the several views thereof, liquid discharge head units and liquid discharge apparatuses according to embodiments of the present disclosure will be described below.

### Configuration of Image Forming Apparatus

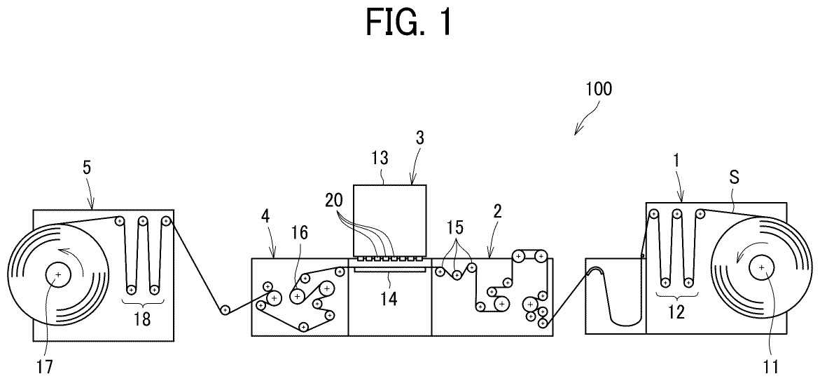

First, with reference to FIG. 1, a description will be given of an inkjet image forming apparatus which is an example of a liquid discharge apparatus according to the present disclosure. FIG. 1 is a diagram illustrating a general arrangement of an image forming apparatus according to a first embodiment.

As illustrated in FIG. 1, an image forming apparatus 100 according to the first embodiment includes a sheet feeding unit 1, a sheet conveying unit 2, an image forming unit 3, a drying unit 4, and a sheet collection unit 5.

The sheet feeding unit 1 includes a feed roller 11 and a tension adjusting mechanism 12. The feed roller 11 feeds a sheet S. The tension adjusting mechanism 12 adjusts the tension of the fed sheet S. The sheet S that is large in length is wound around the feed roller 11 in a roll shape. When the feed roller 11 rotates, the sheet S is unwound and fed from the feed roller 11. The tension adjusting mechanism 12 is a mechanism that adjusts the tension of the sheet S so as to feed the sheet S with a constant tension. In this case, the tension adjusting mechanism 12 includes multiple support rollers. The sheet S is stretched between and supported by the support rollers. Distances between the support rollers are changed to adjust the tension of the sheet S. As a result, the sheet S is fed with a constant tension.

The sheet conveying unit 2 includes multiple conveyance rollers 15 that conveys the sheet S fed from the sheet feeding unit 1 to the image forming unit 3. The conveyance roller 15 is an example of a conveyance unit that conveys the sheet S. A conveyance belt or the like may be used as the conveyance unit, in addition to the conveyance roller 15. The sheet S is conveyed to the image forming unit 3 as the multiple conveyance rollers 15 rotates when the sheet S is stretched between the conveyance rollers 15.

The image forming unit 3 includes a liquid discharge head unit 13 for forming an image on the sheet S. The liquid discharge head unit 13 has multiple liquid discharge heads 20 mounted thereon. The liquid discharge heads 20 discharge liquid ink onto the sheet S. The image forming unit 3 also includes a conveyance guide 14 that guides the sheet S being conveyed. The conveyance guide 14 is disposed in such a way as to face the liquid discharge head unit 13. When the sheet S is conveyed to the image forming unit 3, the sheet S is guided by the conveyance guide 14, and ink is discharged from the liquid discharge heads 20 onto the sheet S to form an image on the sheet S. Here, the present embodiment assumes that the liquid discharge head 20 is a so-called line-type liquid discharge head that discharges ink when the liquid discharge head remains stationary with respect to the sheet S being conveyed. Meanwhile, the liquid discharge head 20 is not limited to the so-called line-type liquid discharge head, and may be a so-called serial-type liquid discharge head that discharges ink while moving in a sheet width direction with respect to the sheet S remaining stationary.

The drying unit 4 includes a heating roller 16 that heats the sheet S. The heating roller 16 is an example of a heating unit that heats the sheet S. The heating roller 16 includes a heat source provided therein, such as a halogen heater. When the sheet S is conveyed in the state of being wound around an outer peripheral surface of the heating roller 16, the sheet S is heated by the heating roller 16, and a liquid component contained in the ink on the sheet S is evaporated. As a result, the sheet S is dried. In addition to a contact-type heating unit such as the heating roller 16, a non-contact heating unit, such as a hot air generator that blows hot air onto the sheet S, may also be used as the heating unit that heats the sheet S.

The sheet collection unit 5 includes a collection roller 17 and a tension adjusting mechanism 18. The collection roller 17 winds and collects the sheet S. The tension adjusting mechanism 18 adjusts the tension of the sheet S. When the sheet S is conveyed to the sheet collection unit 5, the sheet S is wound into a roll shape and collected by the collection roller 17 that is rotating. The tension adjusting mechanism 18 has the same configuration as, for example, the tension adjusting mechanism 12 of the sheet feeding unit 1. Thus, when the sheet S is conveyed to the sheet collection unit 5, the sheet S is wound with a constant tension and collected. The tension adjusting mechanism 18 may have a configuration different from the tension adjusting mechanism 12 of the sheet feeding unit 1.

### Control Configuration of Image Forming Apparatus

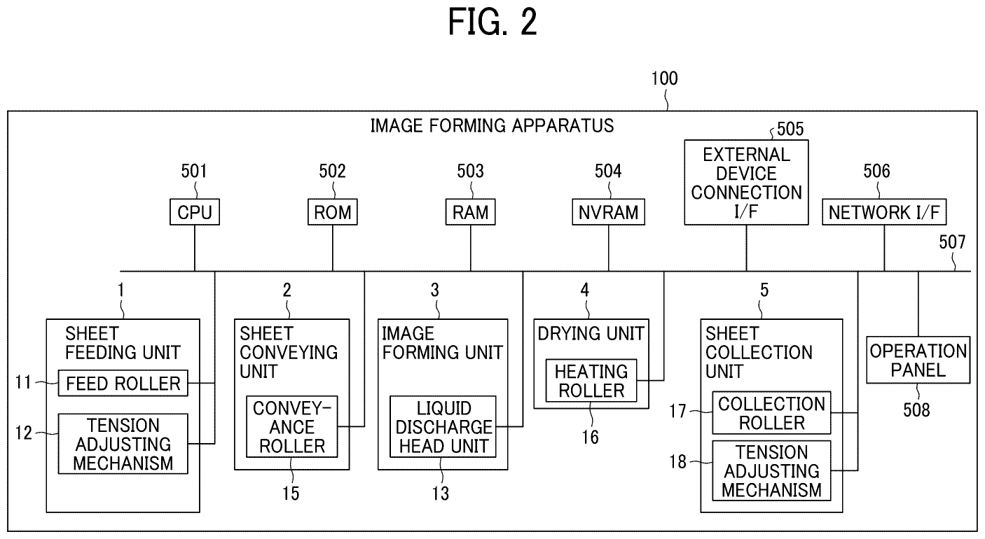

FIG. 2 is a control block diagram of the image forming apparatus according to the first embodiment.

As illustrated in FIG. 2, the image forming apparatus 100 according to the first embodiment includes a central processing unit (CPU) 501, a read only memory (ROM) 502, a random access memory (RAM) 503, a non-volatile random access memory (NVRAM) 504, an external device connection interface (I/F) 505, a network I/F 506, a bus line 507 and an operation panel 508.

The CPU 501 is an arithmetic unit that controls the entire operation of the image forming apparatus 100. Specifically, the CPU 501 controls operation of the liquid discharge head unit 13, rotational speeds of the feed roller 11, the collection roller 17, and the conveyance rollers 15, the temperature of the heating roller 16, and tension adjusting operation of the tension adjusting mechanisms 12 and 18. The ROM 502 is a read-only non-volatile storage medium that stores programs and the like to be used for driving the CPU 501 such as an initial program loader (IPL). The RAM 503 is a volatile storage medium that allows data to be read and written at high speed. The CPU 501 uses the RAM 503 as a working area for data processing. The NVRAM 504 is a non-volatile storage medium that allows the reading and writing of data, and stores various types of data such as a setting value and a program necessary for controlling each unit of the image forming apparatus 100. A program stored in the ROM 502 is read into the RAM 503. According to the program loaded into the RAM 503, the CPU 501 performs arithmetic operation to control each unit of the image forming apparatus 100. At this time, the CPU 501 uses a setting value or the like stored in the NVRAM 504.

The external device connection I/F 505 is connected to a personal computer (PC) by a universal serial bus (USB) cable or the like, and performs data communication with the PC with respect to a control signal and data on an image to be printed. The network I/F 506 is an interface for performing data communication by using a communication network such as the Internet. The bus line 507 is an address bus, a data bus, and the like for electrically connecting components such as the CPU 501 to each other.

The operation panel 508 is a touch-panel input unit that displays a current setting value, a selection screen, and the like and receives an input from an operator. When various types of information such as image information, a sheet conveyance speed, and a sheet type are input via the operation panel 508, the CPU 501 controls various types of operation of the image forming apparatus 100 on the basis of the input information.

### Configuration of Liquid Discharge Head Unit

Next, a description will be given of a configuration of the liquid discharge head according to the first embodiment.

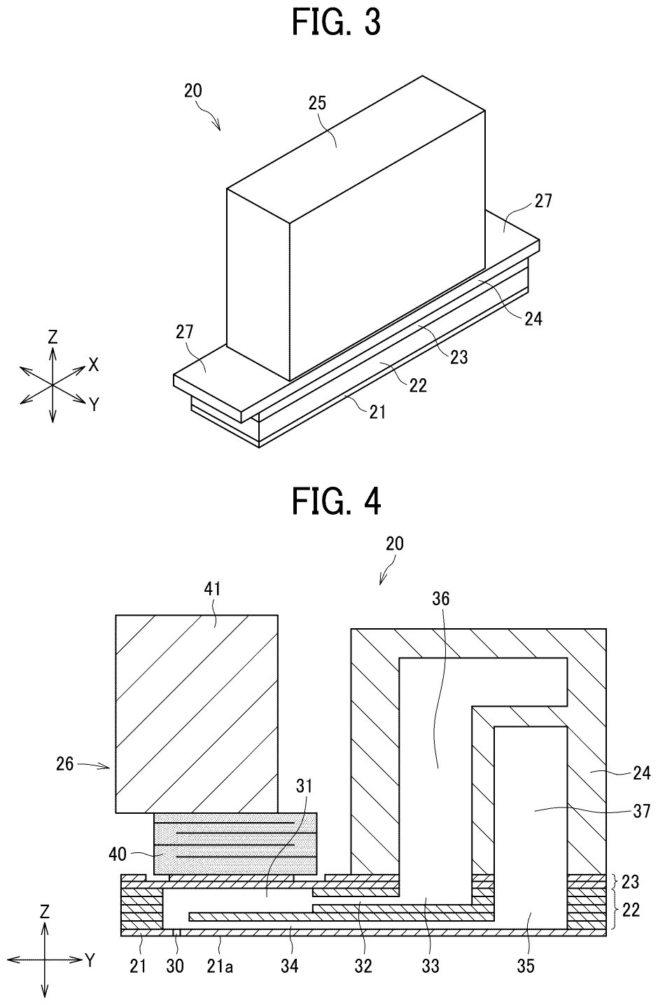

FIG. 3 is an external perspective view of the liquid discharge head according to the first embodiment.

As illustrated in FIG. 3, the liquid discharge head 20 according to the first embodiment is formed in a longitudinal shape elongated in an X direction in the drawing, as a whole. The X direction, a Y direction, and a Z direction in FIG. 3 indicate directions of three-dimensional coordinate axes of the liquid discharge head 20 according to the first embodiment. In this case, the X direction indicates a direction parallel to a longitudinal direction of the liquid discharge head 20, and the Y direction indicates a direction orthogonal to the X direction when the liquid discharge head 20 is viewed from above in the Z direction. The Z direction is a direction orthogonal to each of the X direction and the Y direction. Note that the X direction, the Y direction, and the Z direction in the other drawings also indicate the same directions as the X direction, the Y direction, and the Z direction in FIG. 3.

The liquid discharge head 20 according to the first embodiment includes a nozzle plate 21, a channel plate 22, a diaphragm member 23, a common channel member 24, a cover member 25, and the like. The nozzle plate 21, the channel plate 22, the diaphragm member 23, and the common channel member 24 are stacked in layers and joined in this order. The cover member 25 is a member that covers and protects a driving integrated circuit (IC), a flexible wiring board, and the like. The driving IC controls the driving of a piezoelectric element included in the diaphragm member 23. The flexible wiring board transmits a drive signal to the piezoelectric element.

The nozzle plate 21, the channel plate 22, the diaphragm member 23, and the common channel member 24 are formed in a rectangular plate shape. In the first embodiment, a plate-like member forming the common channel member 24 is disposed between the cover member 25 in a rectangular parallelepiped shape and a laminated plate-like block including a combination of the nozzle plate 21, the channel plate 22, and the diaphragm member 23, and extends toward both outer sides of the liquid discharge head 20 in the longitudinal direction (X direction) further than the nozzle plate 21, the channel plate 22, the diaphragm member 23, and the cover member 25. As a result, the common channel member 24 forms a pair of flanges 27 extending toward both outer sides of the liquid discharge head 20 in the longitudinal direction.

FIG. 4 is a cross-sectional view of the liquid discharge head 20 according to the first embodiment.

As illustrated in FIG. 4, the nozzle plate 21 includes a nozzle 30 that discharges liquid. Although just a single nozzle 30 is illustrated here, multiple nozzles 30 is provided side by side in the longitudinal direction X of the liquid discharge head 20 (a direction orthogonal to the plane of FIG. 4). Therefore, the multiple nozzles 30 is opened on a nozzle face 21a facing a liquid discharge direction of the nozzle plate 21.

The channel plate 22 includes multiple pressure chambers 31, individual supply channels 32, one or more intermediate supply channels 33, multiple individual collection channels 34, and one or more intermediate collection channels 35. The multiple pressure chambers 31 separately communicates with the multiple nozzles 30. The individual supply channels 32 separately communicate with the multiple pressure chambers 31. The one or more intermediate supply channels 33 communicate with one or more of the individual supply channels 32. The multiple individual collection channels 34 separately communicates with the multiple pressure chambers 31. The one or more intermediate collection channels 35 communicate with one or more of the individual collection channels 34.

The common channel member 24 includes a common supply channel 36 and a common collection channel 37. The common supply channel 36 is a common channel communicating with the multiple individual supply channels 32 via the intermediate supply channel 33. The common collection channel 37 is a common channel communicating with the multiple individual collection channels 34 via the intermediate collection channel 35. The common supply channel 36, the intermediate supply channel 33, and the individual supply channels 32 communicating with each other function as a supply channel for supplying ink from a supply tank provided in a circulation device or the like to the inside of the pressure chamber 31. Meanwhile, the common collection channel 37, the intermediate collection channel 35, and the individual collection channels 34 communicating with each other function as a collection channel for collecting ink from the pressure chamber 31 to a collection tank of the circulation device or the like.

The diaphragm member 23 includes multiple displaceable diaphragms forming wall surfaces of the pressure chambers 31 of the channel plate 22. A piezoelectric actuator 26 is provided such that the piezoelectric actuator 26 and the pressure chamber 31 are located on opposite sides of the diaphragm member 23. The piezoelectric actuator 26 includes an electromechanical transducer as a drive unit for deforming the diaphragm member 23.

The piezoelectric actuator 26 includes a piezoelectric element 40 and a base member 41 to which the piezoelectric element 40 is joined. The piezoelectric element 40 is, for example, one in which a piezoelectric layer and an internal electrode are alternately layered. The internal electrode is extended to an end face of the piezoelectric element 40 and connected to a flexible wiring member via an external electrode.

When a drive voltage is applied to the piezoelectric element 40, the piezoelectric element 40 extends or contracts. Specifically, first, when a voltage lower than a reference potential (intermediate potential) is applied to the piezoelectric element 40, the piezoelectric element 40 contracts. As a result, the diaphragm member 23 is pulled to cause the volume of the pressure chamber 31 to expand, and ink flows into the pressure chamber 31. Thereafter, when a voltage to be applied to the piezoelectric element 40 is increased to extend the piezoelectric element 40, the diaphragm member 23 is pushed to cause the volume of the pressure chamber 31 to contract. As a result, ink in the pressure chamber 31 is pressurized and discharged from the nozzle 30. Ink that has not been discharged from the nozzle 30 passes through the individual collection channel 34, the intermediate collection channel 35, and the common collection channel 37, and is sent from a collection port to the collection tank. Thus, the ink is collected.

The method for discharging ink is not limited to the method using the piezoelectric element 40, and may be a charge control method for discharging ink by using an electrostatic attractive force, or a thermal inkjet method for discharging ink by using the pressure of air bubbles generated by the heating of the ink.

### Issue in Height Adjustment of Liquid Discharge Head

Here, an issue in height adjustment of the liquid discharge head will be described with reference to a configuration of a comparative example different from the present disclosure.

FIG. 44 is a diagram illustrating a configuration of a liquid discharge head unit according to a comparative example.

As illustrated in FIG. 44, the liquid discharge head unit according to the comparative example includes a liquid discharge head 200 and a support 500 that supports the liquid discharge head 200. In this case, the liquid discharge head 200 is inserted into an opening 500a in the support 500, and a pair of flanges 200b of the liquid discharge head 200 comes into contact with the support 500. Thus, the liquid discharge head 200 is supported by the support 500. As described above, when the liquid discharge head 200 is supported by the support 500, the position of the liquid discharge head 200 in a vertical direction in FIG. 44 is determined. Thus, a distance G between a nozzle face 200a of the liquid discharge head 200 and a sheet S is maintained at a predetermined distance.

Incidentally, there is a case where it is preferable to change the distance between a sheet and a nozzle face while maintaining the basic structure of a liquid discharge head. For example, when it is desired to apply a liquid discharge head as a high-resolution liquid discharge head, it is necessary to shorten (reduce) the distance between a nozzle face and a sheet. In some conventional image forming apparatuses, the height of a liquid discharge head is changed by a lifting device or the like so that the distance between a nozzle face and a sheet can be adjusted. However, the existing height adjusting mechanism cannot cope with a case where the height of the liquid discharge head needs to be adjusted beyond a preset adjustment range. In this case, the issue of cost increase is caused by a significant change in the shape of the liquid discharge head or a support. In addition, when the shape of the liquid discharge head or the support is changed, it may be necessary to prepare a new jig to be used for attaching the liquid discharge head to the support. This also causes the issue of cost increase. A nozzle face of the liquid discharge head is basically disposed in parallel with a sheet so as not to be inclined with respect to the sheet. However, the nozzle face 200a may be disposed in such a way as to be inclined with respect to the sheet S as illustrated in FIG. 45 due to an influence of a dimensional tolerance or an attachment error of an attachment member for attaching the liquid discharge head. In such a case, it is necessary to adjust the height of at least one of the left or right side of the liquid discharge head 200 in FIG. 45 to make the nozzle face 200a parallel to the sheet S.

Therefore, in order to adjust the height of the liquid discharge head without significantly changing the shapes of the liquid discharge head and the support, a configuration of the liquid discharge head unit and a method for adjusting the height of the liquid discharge head are proposed in the first embodiment as follows. Hereinafter, a description will be given of a configuration of the liquid discharge head unit and a method for adjusting the height of the liquid discharge head according to the first embodiment.

### Configuration of Liquid Discharge Head Unit

First, a configuration of the liquid discharge head unit according to the first embodiment will be described.

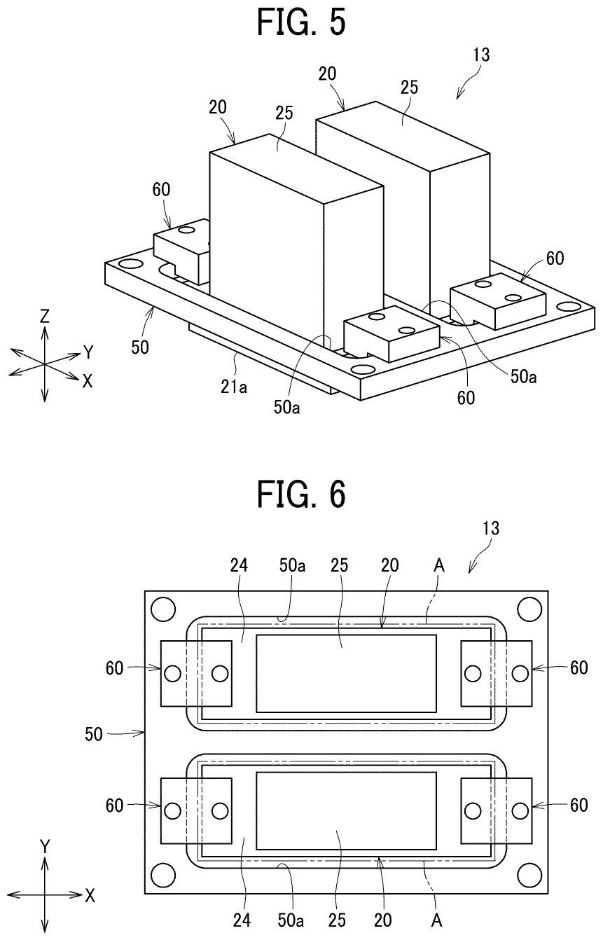

FIG. 5 is an external perspective view of the liquid discharge head unit according to the first embodiment.

As illustrated in FIG. 5, the liquid discharge head unit 13 includes the liquid discharge heads 20, a support 50, and couplers 60.

The support 50 is a plate-like or frame-like member that supports the liquid discharge heads 20. In this case, the support 50 has two openings 50a into which the liquid discharge heads 20 are inserted. Here, the support 50 has the two openings 50a. Meanwhile, the support 50 may have a single opening 50a or three or more openings 50a.

The coupler 60 is a member that couples the liquid discharge head 20 to the support 50. In this case, the coupler 60 is disposed on each end side of the liquid discharge head 20 in the longitudinal direction (X direction) when the liquid discharge head 20 is inserted into the opening 50a in the support 50 from above in FIG. 5. Then, the coupler 60 is secured to the liquid discharge head 20 and the support 50 by means of a fixing member such as a screw or a bolt, an adhesive, or the like. As a result, the liquid discharge head 20 is coupled to the support 50.

When the liquid discharge head 20 is supported by the support 50, the nozzle face 21a of the liquid discharge head 20 is disposed below the support 50 in FIG. 5. That is, the nozzle face 21a is disposed closer to a sheet than the support 50 in a “height direction” (Z direction), which is a direction in which the liquid discharge head 20 is inserted into the opening 50a in the support 50. The term “height direction” mentioned here refers to a direction in which the liquid discharge head 20 is inserted into the opening 50a in the support 50, but the term “height direction” does not necessarily refer only to a direction (vertical direction) perpendicular to a horizontal plane. For example, when the liquid discharge head 20 is inserted in an oblique direction with respect to the horizontal plane, the “height direction” refers to the oblique direction in which the liquid discharge head 20 is inserted, and when the liquid discharge head 20 is inserted in a direction parallel to the horizontal plane, the “height direction” refers to the horizontal direction in which the liquid discharge head 20 is inserted.

FIG. 6 is a plan view of the liquid discharge head unit according to the first embodiment.

As illustrated in FIG. 6, the opening 50a in the support 50 is made larger than an outer size A of the liquid discharge head 20 indicated by a two-dot chain line, so as not to interfere with the liquid discharge head 20. The outer size A is a maximum outer size of a portion to be inserted into the opening 50a when the liquid discharge head 20 is viewed from a direction orthogonal to the nozzle face 21a (state of being vertically projected). In this case, an outer size of the common channel member 24 forming the liquid discharge head 20 corresponds to the outer size A of the liquid discharge head 20. As described above, the opening 50a in the support 50 is made larger than the outer size A of the common channel member 24 to be inserted into the opening 50a. Therefore, the liquid discharge head 20 is inserted into the opening 50a without coming into contact with the support 50.

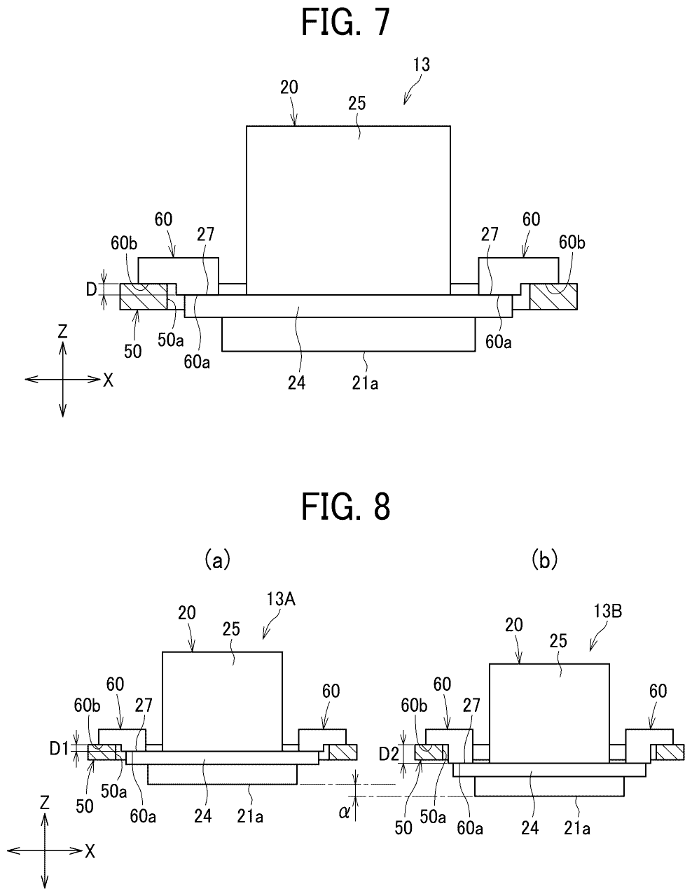

FIG. 7 is a cross-sectional view of the liquid discharge head unit according to the first embodiment.

As illustrated in FIG. 7, a single coupler 60 is disposed at each end of each liquid discharge head 20 in the longitudinal direction (X direction), and is secured to the liquid discharge head 20 and the support 50. In this case, each of the couplers 60 has a first contact 60a and a second contact 60b. The first contact 60a is in contact with the flange 27 extending toward each outer side of the liquid discharge head 20 in the longitudinal direction. The second contact 60b is in contact with the support 50. Here, the first contact 60a and the second contact 60b are disposed in such a way as to be in direct contact with the flange 27 of the liquid discharge head 20 and the support 50, respectively. Meanwhile, the first contact 60a may be in direct contact with the flange 27, or may be in indirect contact with the flange 27 via a height adjuster to be described below. That is, in the present embodiment, the “contact” between the first contact 60a and the flange 27 and the “contact” between the second contact 60b and the support 50 include not only direct contact but also indirect contact. The support 50 has an opening 50a into which at least a discharge side (lower end side in FIG. 7) of the liquid discharge head 20 is insertable in the discharge direction (downward direction in FIG. 7).

In the first embodiment, the first contact 60a and the second contact 60b of the coupler 60 are formed of downward-facing surfaces of the coupler 60 (surfaces facing in the same direction) in FIG. 7. Therefore, in this case, the first contact 60a comes into contact with an upward-facing surface of the flange 27 in FIG. 7, and the second contact 60b comes into contact with an upward-facing surface of the support 50 in FIG. 7. Furthermore, in this case, since the lower side in FIG. 7 corresponds to the liquid discharge direction of the liquid discharge head 20, it can be said that the first contact 60a and the second contact 60b of the coupler 60 are each provided on a surface facing the liquid discharge direction. Therefore, in this case, the first contact 60a and the second contact 60b are in contact with a surface of the flange 27 and a surface of the support 50, respectively, the surfaces facing a direction opposite to the liquid discharge direction or facing a direction opposite to a sheet side.

As described above, the first contact 60a and the second contact 60b are formed of surfaces facing the same direction, but positions of the first contact 60a and the second contact 60b are different from each other in the height direction (Z direction). In this case, the first contact 60a is located lower (in the liquid discharge direction) in FIG. 7 than the second contact 60b by a distance D in the height direction.

When each coupler 60 is secured to the liquid discharge head 20 and the support 50 when the first contact 60a is in contact with the upper face of the flange 27 and the second contact 60b is in contact with the upper face of the support 50, the liquid discharge head 20 is held in such a way as to be hanged from the support 50 as illustrated in FIG. 7.

As described above, in the first embodiment, since the liquid discharge head 20 is held in such a way as to be suspended from the support 50, it is possible to reduce the height of the nozzle face and also reduce the distance G between the sheet and the nozzle face as compared with the liquid discharge head 200 according to the comparative example of FIG. 44. That is, unlike the comparative example, the flange 27 is held in the state of entering the opening 50a without coming into contact with the upper face of the support 50 in the first embodiment. Therefore, a lower surface of the flange 27 of the liquid discharge head 20 is located below the upper face of the support 50 (see FIG. 7). As a result, the height of the nozzle face 21a can be reduced, and the distance G between the nozzle face and the sheet can also be reduced.

### Method for Adjusting Height of Liquid Discharge Head

Next, a method for adjusting the height of the liquid discharge head will be described.

FIG. 8 illustrates an exemplary height adjustment in the first embodiment.

In this case, a height difference D1 between the first contact 60a and the second contact 60b of the coupler 60 in a liquid discharge head unit 13A illustrated in FIG. 8(a) on the left side is different from a height difference D2 between the first contact 60a and the second contact 60b of the coupler 60 in a liquid discharge head unit 13B illustrated in FIG. 8(b) on the right side, as illustrated in FIGS. 8(a) and 8(b). In the example of FIGS. 8(a) and 8(b), the height difference D2 between the first contact 60a and the second contact 60b of the coupler 60 illustrated in FIG. 8(b) on the right side is set to a value larger than the height difference D1 between the first contact 60a and the second contact 60b of the coupler 60 illustrated in FIG. 8(a) on the left side (D2>D1). Therefore, the nozzle face 21a is lower in the liquid discharge head unit 13B on the right side than in the liquid discharge head unit 13A on the left side since the height difference D2 between the first contact 60a and the second contact 60b is larger (D2−D1=α).

As described above, it is possible to adjust the height of the nozzle face 21a by making the height differences between the first contact 60a and the second contact 60b different. That is, when it is desired to lower the height of the nozzle face 21a, the height difference D2 between the first contact 60a and the second contact 60b is increased as illustrated in FIG. 8(b). In contrast, when it is desired to increase the height of the nozzle face 21a, the height difference D1 between the first contact 60a and the second contact 60b is reduced as illustrated in FIG. 8(a). Thus, the height of the nozzle face 21a can be adjusted.

Furthermore, in this case, it is possible to adjust the height of the nozzle face 21a simply by changing the coupler 60 to another coupler 60 with a different height difference between the first contact 60a and the second contact 60b. As a result, the shapes of the liquid discharge head 20 and the support 50 do not need to be significantly changed so as to adjust the height of the nozzle face 21a. Therefore, the height adjustment method according to the first embodiment makes it possible to avoid an increase in cost due to a significant change in the shape of the liquid discharge head 20 or the support 50. It is thus possible to adjust the height of the liquid discharge head (nozzle face) at low cost.

### Height Adjustment Member

Next, a description will be given of a height adjustment method to be performed by means of a height adjuster.

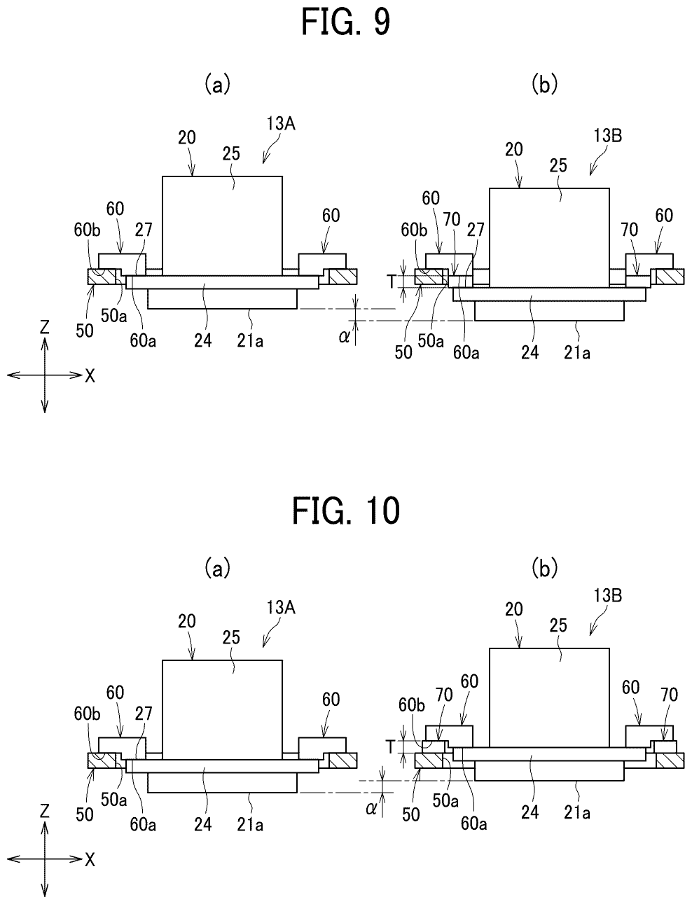

FIG. 9 illustrates an exemplary height adjustment to be performed by means of the height adjusters.

In the example of FIGS. 9(a) and 9(b), a height adjuster 70 is interposed between the first contact 60a of the coupler 60 and the flange 27 of the liquid discharge head 20 illustrated in FIG. 9(b) on the right side. Meanwhile, no height adjuster 70 is interposed between the first contact 60a of the coupler 60 and the flange 27 of the liquid discharge head 20 illustrated in FIG. 9(a) on the left side.

As described above, by interposing the height adjuster 70 between the first contact 60a and the flange 27, it is possible to make the nozzle face 21a lower in the liquid discharge head unit 13B on the right side than in the liquid discharge head unit 13A on the left side by a thickness T of the height adjuster 70 (T=α). Furthermore, by appropriately changing the thickness T of the height adjuster 70, it is possible to make an adjustment in such a way as to change the height of the nozzle face 21a to a desired height.

The configuration of the coupler 60 and other portions in FIGS. 9(a) and 9(b) is the same as the configuration of the first embodiment except for the fact that the height adjuster 70 is used in FIGS. 9(a) and 9(b). Furthermore, in FIGS. 9(a) and 9(b), the couplers 60 provided in the liquid discharge head unit 13A on the left side and the couplers 60 provided in the liquid discharge head unit 13B on the right side have the same dimensions and shape, but these couplers 60 may have different dimensions and shapes. That is, the height difference between the first contact 60a and the second contact 60b may differ between the coupler 60 provided in the liquid discharge head unit 13A on the left side and the coupler 60 provided in the liquid discharge head unit 13B on the right side.

FIG. 10 illustrates another exemplary height adjustment to be performed by means of the height adjusters.

Unlike the above-described example of FIGS. 9(a) and 9(b), the height adjuster 70 in the example of FIGS. 10(a) and 10(b) is interposed between the second contact 60b of the coupler 60 and the support 50 illustrated in FIG. 10(b) on the right side. That is, a position where the height adjuster 70 is interposed is different. Except for this point, the example of FIGS. 10(a) and 10(b) is the same as the example of FIGS. 9(a) and 9(b).

As described above, in contrast to the above-described example of FIGS. 9(a) and 9(b), it is possible to make the nozzle face 21a of the liquid discharge head unit 13B on the right side higher by interposing the height adjuster 70 between the second contact 60b of the coupler 60 and the support 50 in the example of FIGS. 10(a) and 10(b). That is, the height of the nozzle face 21a can be made higher in the liquid discharge head unit 13B on the right side than in the liquid discharge head unit 13A on the left side by the thickness T of the height adjuster 70 (T=α). Therefore, when it is desired to raise the nozzle face 21a, it is preferable to interpose the height adjuster 70 between the second contact 60b of the coupler 60 and the support 50 as illustrated in FIGS. 10(a) and 10(b). Meanwhile, when it is desired to lower the nozzle face 21a, the height adjuster 70 just needs to be interposed between the first contact 60a and the flange 27 as illustrated in FIGS. 9(a) and 9(b).

Also in FIGS. 10(a) and 10(b), the couplers 60 provided in the liquid discharge head unit 13A on the left side and the couplers 60 provided in the liquid discharge head unit 13B on the right side have the same dimensions and shape, but the couplers 60 provided in the liquid discharge head units 13A and 13B may have different dimensions and shapes. Furthermore, the height difference between the first contact 60a and the second contact 60b may differ between the coupler 60 provided in the liquid discharge head unit 13A on the left side and the coupler 60 provided in the liquid discharge head unit 13B on the right side.

Next, other embodiments will be described. In the following description of the other embodiments, differences from the first embodiment will be mainly described, and description of the same portions will be omitted as appropriate.

### Second Embodiment

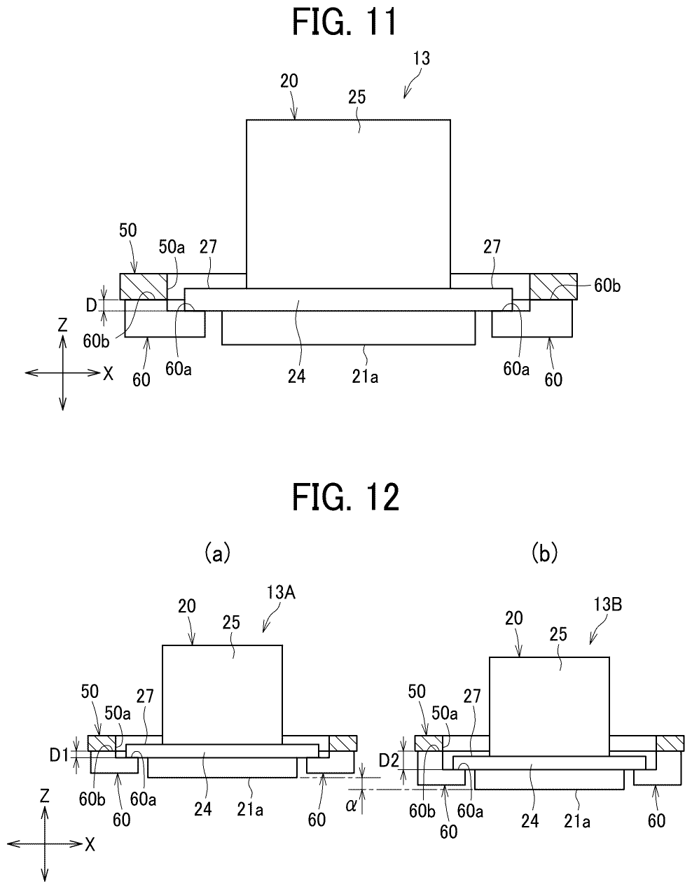

FIG. 11 is a cross-sectional view of a liquid discharge head unit according to a second embodiment.

Unlike the first embodiment, the coupler 60 in the second embodiment illustrated in FIG. 11 is disposed below the flange 27 of the liquid discharge head 20 and the support 50 in the drawing. Therefore, in the second embodiment, the first contact 60a and the second contact 60b are in contact with downward-facing surfaces of the flange 27 and the support 50, respectively. In other words, the first contact 60a and the second contact 60b are in contact with surfaces of the flange 27 and the support 50, respectively, the surfaces facing the liquid discharge direction or facing a sheet side.

Thus, the coupler 60 may be disposed below (in the liquid discharge direction) the flange 27 and the support 50. Furthermore, also in the coupler 60 having such a configuration, it is possible to adjust the height of the liquid discharge head 20 (nozzle face 21a) by changing the height difference D (see FIG. 11) between the first contact 60a and the second contact 60b.

That is, as illustrated in FIGS. 12(a) and 12(b), it is possible to adjust the height of the liquid discharge head 20 (nozzle face 21a) by making the height difference D1 between the first contact 60a and the second contact 60b of the coupler 60 in the liquid discharge head unit 13A on the left side different from the height difference D2 between the first contact 60a and the second contact 60b of the coupler 60 in the liquid discharge head unit 13B on the right side.

As described above, also in the second embodiment, it is possible to adjust the height of the nozzle face 21a simply by changing the height difference between the first contact 60a and the second contact 60b without significantly changing the shapes of the liquid discharge head 20 and the support 50. Therefore, the height of the liquid discharge head (nozzle face) can be adjusted at low cost also by the height adjustment method according to the second embodiment.

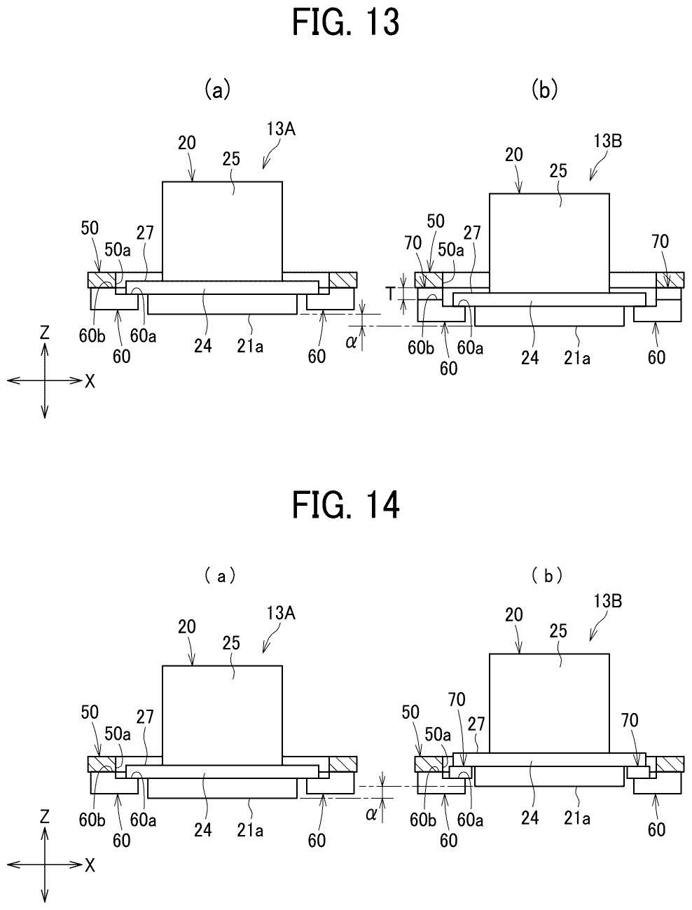

Also in the configuration of the second embodiment, it is possible to perform height adjustment by using the above-described height adjuster 70. For example, it is possible to lower the nozzle face 21a by interposing the height adjuster 70 between the second contact 60b of the coupler 60 and the support 50 in the liquid discharge head unit 13B on the right side, as shown in the example of FIGS. 13(a) and 13(b). Meanwhile, in contrast, the nozzle face 21a can be raised when the height adjuster 70 is interposed between the first contact 60a of the coupler 60 and the flange 27 of the liquid discharge head 20 in the liquid discharge head unit 13B on the right side, as shown in the example of FIGS. 14(a) and 14(b).

### Method for Adjusting Inclination of Liquid Discharge Head

Next, a description will be given of a method for adjusting inclination of the liquid discharge head.

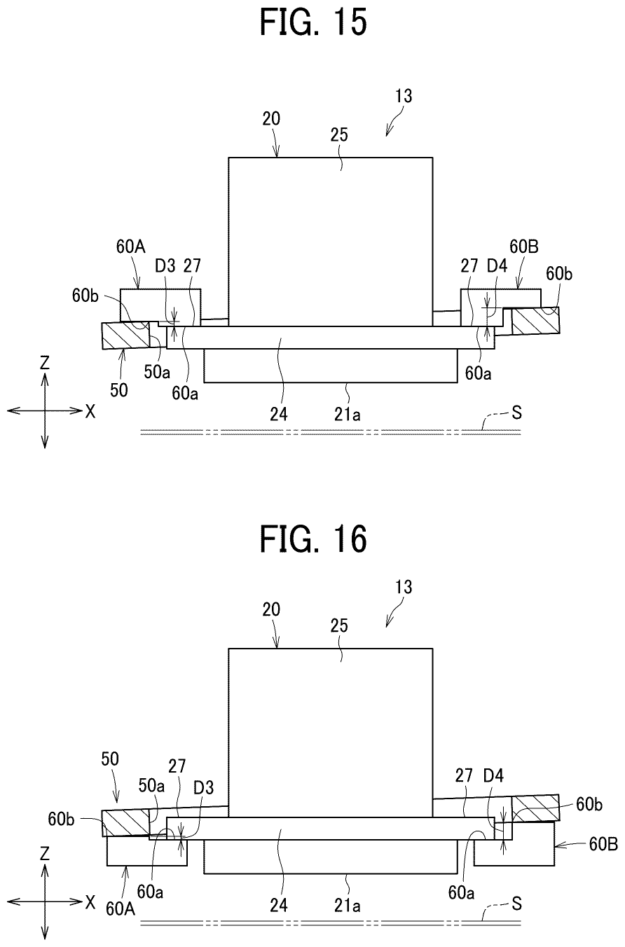

FIG. 15 is a diagram illustrating an exemplary inclination adjustment in the first embodiment.

When the support 50 is inclined with respect to the sheet S as illustrated in FIG. 15, it is possible to adjust (correct) the inclination of the liquid discharge head 20 (nozzle face 21a) by making a height differences D3 between the first contact 60a and the second contact 60b of a first coupler 60A disposed at one longitudinal end of the liquid discharge head 20 different from a height difference D4 between the first contact 60a and the second contact 60b of a second coupler 60B disposed at the other longitudinal end of the liquid discharge head 20. In this case, the height difference D4 between the first contact 60a and the second contact 60b of the second coupler 60B on the right side in the drawing is made larger than the height difference D3 between the first contact 60a and the second contact 60b of the first coupler 60A on the left side in the drawing (D4 >D3). As a result, the inclination of the support 50 with respect to the sheet S is offset. It is thus possible to dispose the nozzle face 21a parallel to the sheet S.

Thus, it is possible to adjust the inclination of the liquid discharge head 20 (nozzle face 21a) by making the height differences D3 between the first contact 60a and the second contact 60b of the first coupler 60A disposed at the one longitudinal end of the liquid discharge head 20 different from the height difference D4 between the first contact 60a and the second contact 60b of the second coupler 60B disposed at the other longitudinal end of the liquid discharge head 20.

In addition, it is possible to make such an inclination adjustment not only by using the configuration of the first embodiment but also by using the configuration of the second embodiment.

FIG. 16 is a diagram illustrating an exemplary inclination adjustment in the second embodiment.

As illustrated in FIG. 16, even in the configuration in which the first coupler 60A and the second coupler 60B are each disposed below the flange 27 and the support 50, it is possible to adjust the inclination of the liquid discharge head 20 with respect to the support 50 by making the height differences D3 between the first contact 60a and the second contact 60b of the first coupler 60A disposed at the one longitudinal end (left side in the drawing) of the liquid discharge head 20 different from the height difference D4 between the first contact 60a and the second contact 60b of the second coupler 60B disposed at the other longitudinal end (right side in the drawing) of the liquid discharge head 20. Accordingly, also in the second embodiment, the nozzle face 21a can be disposed parallel to the sheet S.

It is also possible to adjust the inclination of the liquid discharge head 20 by using the height adjuster 70.

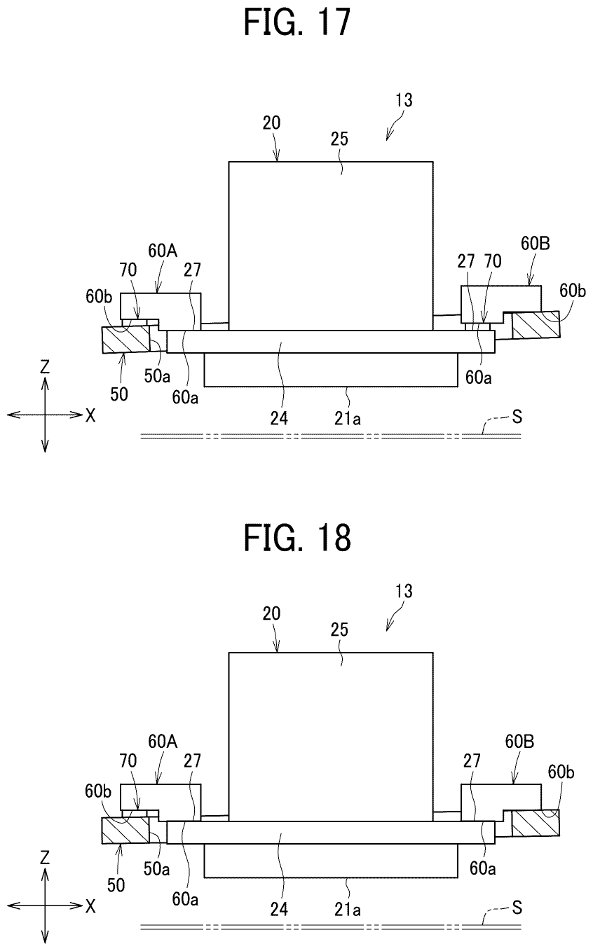

FIG. 17 is a diagram illustrating an exemplary inclination adjustment to be performed by means of the height adjusters.

As illustrated in FIG. 17, it is possible to adjust the inclination of the liquid discharge head 20 by causing a position where the height adjuster 70 is interposed to differ between the right side and the left side. In this case, the inclination of the liquid discharge head 20 is adjusted by the interposition of the height adjuster 70 between the second contact 60b of the first coupler 60A and the support 50 on the left side of FIG. 17 (one longitudinal end of the liquid discharge head 20) and the interposition of the height adjuster 70 between the first contact 60a of the second coupler 60B and the flange 27 of the liquid discharge head 20 on the right side of FIG. 17 (other longitudinal end of the liquid discharge head 20).

Thus, it is possible to offset the inclination of the support 50 with respect to the sheet S and dispose the nozzle face 21a parallel to the sheet S by causing a position where the height adjuster 70 is interposed to differ between the one end and the other end of the liquid discharge head 20. Furthermore, the thickness of the height adjuster 70 disposed on the left side of FIG. 17 may be made different from the thickness of the height adjuster 70 disposed on the right side of FIG. 17, to adjust the inclination of the liquid discharge head 20.

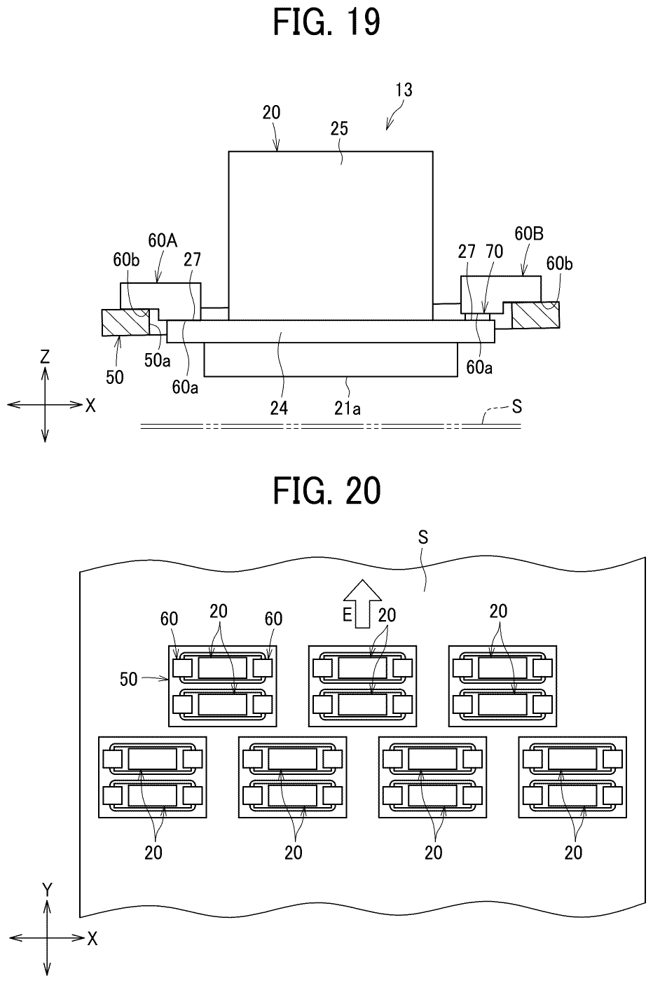

When the inclination of the support 50 with respect to the sheet S is not so large, the height adjuster 70 may be interposed only on the one longitudinal end (left side in the drawing) of the liquid discharge head 20 as shown in the example of FIG. 18. In addition, as shown in the example of FIG. 19, the height adjuster 70 may be interposed only on the other longitudinal end (right side in the drawing) of the liquid discharge head 20. Thus, the height adjuster 70 may be interposed between the second contact 60b of the first coupler 60A disposed on the one end and the support 50 or between the first contact 60a of the second coupler 60B disposed on the other end and the flange 27 of the liquid discharge head 20, to adjust the inclination of the liquid discharge head 20 (nozzle face 21a).

In each of the examples of FIGS. 17 to 19, a coupler having the configuration according to the first embodiment (the configuration of FIG. 7) is used as the coupler 60. Meanwhile, when the coupler 60 according to the second embodiment (the configuration of FIG. 11) is used, it is also possible to adjust the inclination of the liquid discharge head 20 (nozzle face 21a) in the same manner by causing the position where the height adjuster 70 is interposed to differ between the one end and the other end or interposing the height adjuster 70 either on the one end or the other end.

### Method for Adjusting Height of Each of Upstream and Downstream Liquid Discharge Heads

Furthermore, the configuration according to the present disclosure enables heights of multiple liquid discharge heads 20 to be separately adjusted when the support 50 supports the multiple liquid discharge heads 20.

FIG. 20 is a plan view of the supports that support multiple liquid discharge heads, which illustrates an exemplary arrangement of the supports.

In the example of FIG. 20, the supports 50 that support the liquid discharge heads 20 are arranged side by side in both a sheet conveyance direction E (Y direction) and the sheet width direction (X direction) orthogonal thereto. In this case, the supports 50 each support multiple liquid discharge heads 20 arranged in the sheet conveyance direction E. As illustrated in FIG. 20, the liquid discharge heads 20 on an upstream side (lower side in the drawing) and the liquid discharge heads 20 on a downstream side (upper side in the drawing) in the sheet conveyance direction E are arranged in a staggered configuration in the sheet width direction (X direction). As a result, ink can be discharged in such a way as to cover the entire image forming region of the sheet S in the width direction.

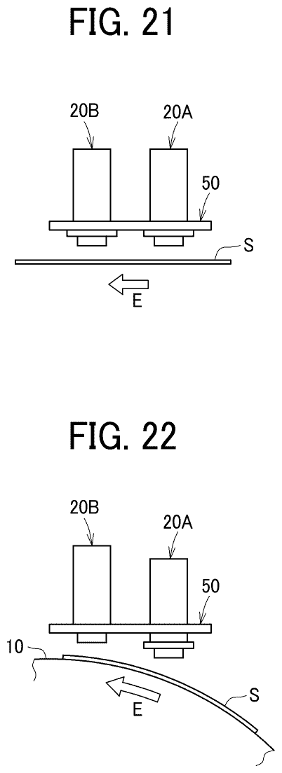

A distance between the nozzle face of each liquid discharge head 20 and the sheet S is preferably equal so as to ensure desired image quality. Therefore, when the support 50 is disposed parallel to the sheet S conveyed in the horizontal direction (disposed horizontally) as illustrated in FIG. 21, it is possible to keep the nozzle faces at a constant distance (equal distance) from the sheet S by making liquid discharge heads 20A and 20B arranged on the upstream side and the downstream side in the sheet conveyance direction E, respectively, equal in height with respect to the support 50. However, when the sheet S is conveyed in an arc-like manner along a conveying drum 10 as illustrated in FIG. 22, the heights of the liquid discharge heads 20A and 20B supported by the support 50 need to be different from each other. Specifically, in the example of FIG. 22, it is possible to keep the nozzle faces at a constant distance (equal distance) from the sheet S by making the height of the liquid discharge head 20A disposed on the upstream side (hereinafter, simply referred to as “upstream side”) in the sheet conveyance direction E lower than the height of the liquid discharge head 20B disposed on the downstream side (hereinafter, simply referred to as “downstream side”) in the sheet conveyance direction E.

Thus, when the sheet is conveyed in an arc-like manner, the height of the liquid discharge head 20A on the upstream side and the height of the liquid discharge head 20B on the downstream side need to be different from each other. In that case, it is possible to use the height adjustment method according to the present disclosure described above for performing height adjustment as follows.

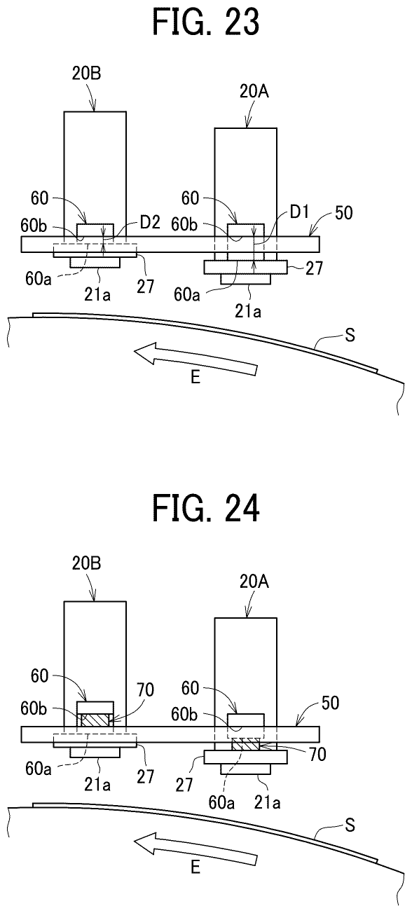

FIG. 23 is a diagram illustrating an exemplary height adjustment between the upstream side and the downstream side, to be performed by couplers having different height differences between contacts.

In the example of FIG. 23, the height difference D1 between the first contact 60a and the second contact 60b of the coupler 60 coupled to the liquid discharge head 20A on the upstream side is made different from the height difference D2 between the first contact 60a and the second contact 60b of the coupler 60 coupled to the liquid discharge head 20B on the downstream side, so as to adjust the heights of the liquid discharge heads 20A and 20B located on the upstream side and the downstream side, respectively. In this case, the height difference D1 between the first contact 60a and the second contact 60b of the coupler 60 on the upstream side is made larger than the height difference D2 between the first contact 60a and the second contact 60b of the coupler 60 on the downstream side. As a result, the height of the liquid discharge head 20A on the upstream side becomes lower than the height of the second coupler 60B on the downstream side. Thus, it is possible to locate the nozzle faces of the liquid discharge heads 20A and 20B disposed on the upstream side and the downstream side, respectively, at the same distance from the sheet S.

FIG. 24 is a diagram illustrating an exemplary height adjustment between the upstream side and the downstream side, to be performed by means of the height adjusters.

In this case, a position where the height adjuster 70 is interposed differs between the liquid discharge head 20A on the upstream side and the liquid discharge head 20B on the downstream side, as illustrated in FIG. 24. Thus, the respective heights of the liquid discharge heads 20A and 20B are adjusted. Specifically, in the example of FIG. 24, the height adjuster 70 is interposed between the first contact 60a of the coupler 60 and the flange 27 at the liquid discharge head 20A on the upstream side, and the height adjuster 70 is interposed between the second contact 60b of the coupler 60 and the support 50 at the liquid discharge head 20B on the downstream side. As a result, the height of the liquid discharge head 20A on the upstream side can be made lower than the second coupler 60B on the downstream side. It is thus possible to locate the nozzle faces of the liquid discharge heads 20A and 20B disposed on the upstream side and the downstream side, respectively, at the same distance from the sheet S.

Thus, it is also possible to perform height adjustment by causing a position where the height adjuster 70 is interposed to differ between the liquid discharge head 20A on the upstream side and the liquid discharge head 20B on the downstream side.

Furthermore, the height adjuster 70 may be interposed either at the liquid discharge head 20A on the upstream side or the liquid discharge head 20B on the downstream side. That is, the height adjuster 70 may be interposed either between the first contact 60a of the coupler 60 on the upstream side and the flange 27 or between the second contact 60b of the coupler 60 on the downstream side and the support 50.

As described above, it is possible to keep the nozzle face of each liquid discharge head at a constant distance from the sheet by adjusting the height of the liquid discharge head on the upstream side and the height of the liquid discharge head on the downstream side. The coupler 60 according to the first embodiment is used as the coupler 60 in the examples of FIGS. 23 and 24. Meanwhile, similarly, the heights of the liquid discharge head 20A on the upstream side and the liquid discharge head 20B on the downstream side can be separately adjusted also when the coupler 60 according to the second embodiment is used. The case where the sheet S is conveyed in an arc-like manner by the conveying drum 10 has been described as an example in FIGS. 23 and 24. Meanwhile, even when the sheet S is conveyed curvilinearly (conveyed on a curved surface) other than being conveyed in an arc-like manner, or conveyed linearly along a line inclined with respect to the horizontal direction, it is also possible to keep the nozzle face of each liquid discharge head at a constant distance from the sheet by adjusting the height of the liquid discharge head on the upstream side and the height of the liquid discharge head on the downstream side.

Next, still another embodiment will now be described. In the embodiment to be described below, description of points common to the embodiment and the first embodiment will be omitted as appropriate.

### Third Embodiment

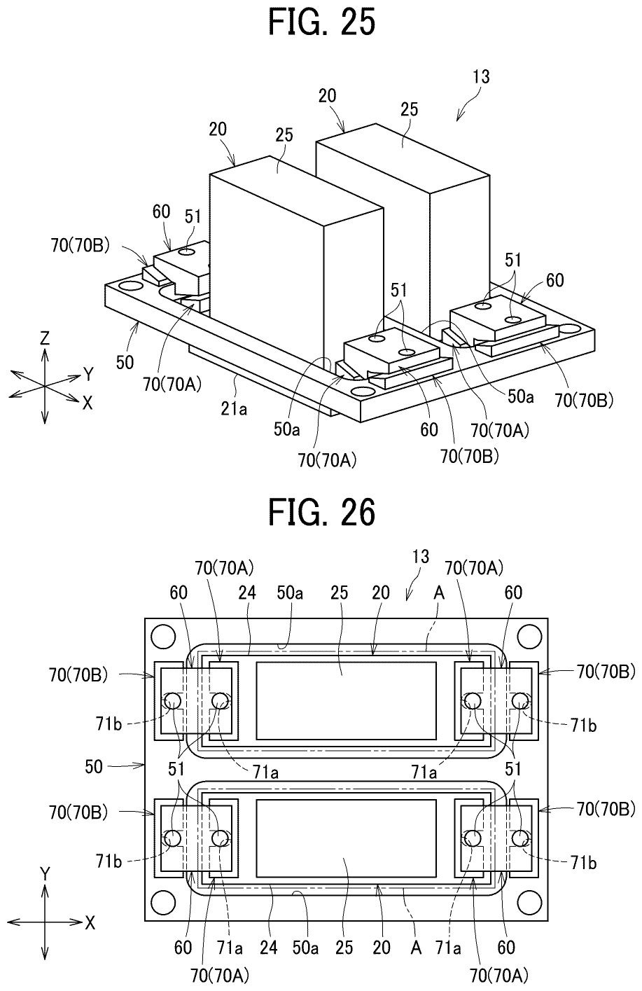

FIG. 25 is an external perspective view of a liquid discharge head unit according to a third embodiment.

As illustrated in FIG. 25, the liquid discharge head unit 13 according to the third embodiment includes the height adjusters 70 in addition to the liquid discharge heads 20, the support 50, and the couplers 60.

The configuration of each of the liquid discharge head 20, the support 50, and the coupler 60 according to the third embodiment is basically the same as the corresponding configuration in the first embodiment. However, in this case, the coupler 60 is secured to the liquid discharge head 20 and the support 50 by means of a fixing member 51 such as a screw or a bolt.

The height adjuster 70 is a member that adjusts the position of the liquid discharge head 20 in the height direction with respect to the support 50. In this case, the height adjuster 70 is interposed between the coupler 60 and the liquid discharge head 20 and between the coupler 60 and the support 50 in the height direction (Z direction). That is, the height adjuster 70 includes a first height adjuster 70A and a second height adjuster 70B. The first height adjuster 70A is interposed between the coupler 60 and the liquid discharge head 20. The second height adjuster 70B is interposed between the coupler 60 and the support 50. In the following description, in order to distinguish the first height adjuster 70A interposed between the coupler 60 and the liquid discharge head 20 from the second height adjuster 70B interposed between the coupler 60 and the support 50, the first height adjuster 70A is referred to as a “first height adjuster”, and the second height adjuster 70B is referred to as a “second height adjuster”.

FIG. 26 is a plan view of the liquid discharge head unit according to the third embodiment.

As illustrated in FIG. 26, the first height adjuster 70A and the second height adjuster 70B have recesses 71a and 71b, respectively, that avoid interference with the fixing member 51. Since the first height adjuster 70A and the second height adjuster 70B have the recesses 71a and 71b, respectively, it is possible to interpose the first height adjuster 70A and the second height adjuster 70B between the coupler 60 and the liquid discharge head 20 and between the coupler 60 and the support 50, respectively, without causing interference with the fixing member 51.

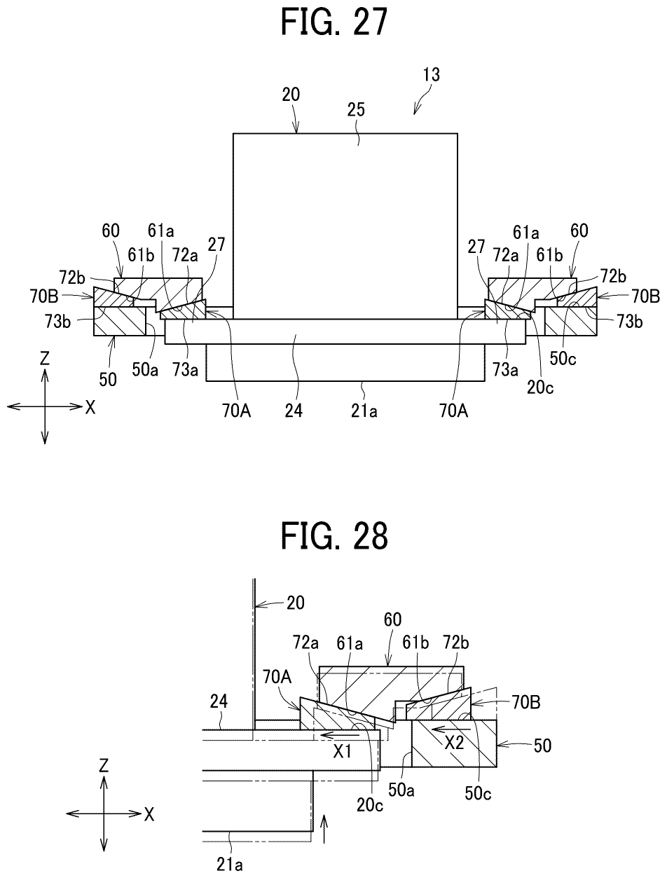

FIG. 27 is a cross-sectional view of the liquid discharge head unit according to the third embodiment.

As illustrated in FIG. 27, the first height adjuster 70A and the second height adjuster 70B are formed in a wedge shape having contact surfaces 73a and 73b and inclined surfaces 72a and 72b, respectively. The contact surfaces 73a and 73b are in contact with the liquid discharge head 20 and the support 50, respectively. The inclined surfaces 72a and 72b are inclined with respect to the contact surfaces 73a and 73b, respectively. That is, the first height adjuster 70A has the contact surface 73a, which is in contact with the liquid discharge head 20 (flange 27), and the inclined surface 72a inclined with respect to the contact surface 73a. Meanwhile, the second height adjuster 70B has the contact surface 73b, which is a horizontal surface in contact with the support 50, and the inclined surface 72b inclined with respect to the contact surface 73b. Inclination angles (for example, inclination angles with respect to the contact surfaces 73a and 73b) of the inclined surfaces 72a and 72b of the first height adjuster 70A and the second height adjuster 70B, respectively may be equal to or different from each other.

The coupler 60 has two inclined surfaces 61a and 61b in contact with the inclined surfaces 72a and 72b of the first height adjuster 70A and the second height adjuster 70B, respectively. The two inclined surfaces 61a and 61b of the coupler 60 are inclined as with the inclined surfaces 72a and 72b of the first height adjuster 70A and the second height adjuster 70B, respectively, when the first height adjuster 70A and the second height adjuster 70B are interposed between the coupler 60 and the liquid discharge head 20 and between the coupler 60 and the support 50, respectively. Therefore, the inclined surfaces 61a and 61b of the coupler 60 are disposed in such a way as to be inclined with respect to the contact surface 73a of the first height adjuster 70A and a contact surface 20c of the liquid discharge head 20 and with respect to the contact surface 73b of the second height adjuster 70B and a contact surface 50c of the support 50, respectively, as with the inclined surfaces 72a and 72b of the first height adjuster 70A and the second height adjuster 70B, respectively.

### Method for Adjusting Height of Liquid Discharge Head

Next, a description will be given of a height adjustment method for the liquid discharge head 20 to be performed by means of the first height adjuster 70A and the second height adjuster 70B. Note that the first height adjuster 70A and the second height adjuster 70B on the right side and the first height adjuster 70A and the second height adjuster 70B on the left side in FIG. 27 have the same configuration except for being arranged symmetrically with respect to the liquid discharge head 20 interposed therebetween, and allow height adjustment to be performed in the same manner. Therefore, a height adjustment method will be described below based on the first height adjuster 70A and the second height adjuster 70B on the right side as an example.

First, a method for increasing the height of the liquid discharge head 20 will be described with reference to FIG. 28. FIG. 28 illustrates the first height adjuster 70A and the second height adjuster 70B that have been shifted from states indicated by two-dot chain lines to states indicated by solid lines.

Here, when the coupler 60 is secured to the liquid discharge head 20 and the support 50 by the fixing members 51 (see FIG. 25 or 26), the first height adjuster 70A and the second height adjuster 70B are sandwiched and held between the coupler 60 and the liquid discharge head 20 and between the coupler 60 and the support 50, respectively, by the securing force of the fixing members 51. However, when the securing by the fixing members 51 is released or eased, the first height adjuster 70A and the second height adjuster 70B are movable between the coupler 60 and the liquid discharge head 20 and between the coupler 60 and the support 50, respectively. That is, the first height adjuster 70A and the second height adjuster 70B are movable in directions (directions other than directions parallel to the inclined surfaces 72a and 72b) intersecting the inclined surfaces 72a and 72b along the contact surface 20c of the liquid discharge head 20 and the contact surface 50c of the support 50 in contact with the first height adjuster 70A and the second height adjuster 70B, respectively.

Therefore, it is possible to raise the liquid discharge head 20 with respect to the support 50 by moving the first height adjuster 70A in a direction (X1 direction in FIG. 28) in which the first height adjuster 70A moves backward with respect to the coupler 60 and also moving the second height adjuster 70B in a direction (X2 direction in FIG. 28) in which the second height adjuster 70B moves forward with respect to the coupler 60, as illustrated in FIG. 28. As a result, the position of the liquid discharge head 20 with respect to the support 50 can be raised in the height direction. Furthermore, since the position of the nozzle face 21a of the liquid discharge head 20 becomes high, the distance between the nozzle face 21a and the sheet can be increased. In this case, although both the first height adjuster 70A and the second height adjuster 70B are moved, it is not always necessary to move both the first height adjuster 70A and the second height adjuster 70B, and either the first height adjuster 70A or the second height adjuster 70B may be moved. However, in this case, a width in which height can be adjusted is smaller than when both the first height adjuster 70A and the second height adjuster 70B are moved.

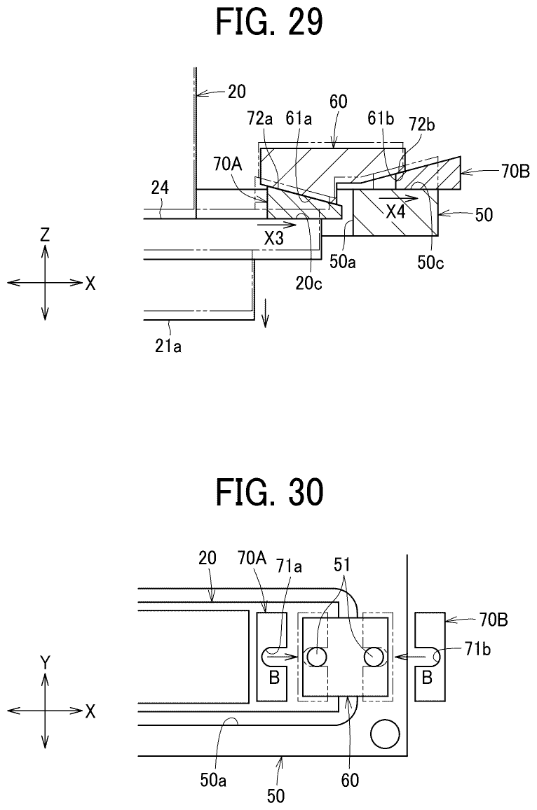

In contrast, when it is desired to lower the height of the liquid discharge head 20, it is possible to lower the position of the liquid discharge head 20 with respect to the support 50 in the height direction by moving the first height adjuster 70A in a direction (X3 direction in FIG. 29) in which the first height adjuster 70A moves forward with respect to the coupler 60, and also moving the second height adjuster 70B in a direction (X4 direction in FIG. 29) in which the second height adjuster 70B moves backward with respect to the coupler 60, as illustrated in FIG. 29. As a result, the position of the nozzle face 21a of the liquid discharge head 20 is lowered. Thus, the distance between the nozzle face 21a and the sheet can be reduced.

Even when the height of the liquid discharge head 20 is lowered, it is not always necessary to move both the first height adjuster 70A and the second height adjuster 70B, and either the first height adjuster 70A or the second height adjuster 70B may be moved. However, in this case, a width in which height can be adjusted is smaller than when both the first height adjuster 70A and the second height adjuster 70B are moved.

Thus, in the third embodiment, the coupler 60 has the inclined surfaces 61a and 61b, and the first height adjuster 70A and the second height adjuster 70B have the inclined surfaces 72a and 72b, respectively, as described above. Therefore, it is possible to make an adjustment in such a way as to change the height of the liquid discharge head 20 to a desired height simply by moving the first height adjuster 70A and the second height adjuster 70B. That is, in the third embodiment, the inclined surfaces 61a and 72a inclined with respect to the contact surface 73a of the first height adjuster 70A in contact with the liquid discharge head 20 serve as surfaces of contact between the coupler 60 and the first height adjuster 70A. In addition, the inclined surfaces 61b and 72b inclined with respect to the contact surface 73b of the second height adjuster 70B in contact with the support 50 serve as surfaces of contact between the coupler 60 and the second height adjuster 70B. As a result, it is possible to adjust the height of the liquid discharge head 20 without significantly changing the shapes of the liquid discharge head 20 and the support 50. Therefore, according to the third embodiment, it is possible to adjust the height of the liquid discharge head 20 while avoiding an increase in cost due to a significant design change of the liquid discharge head 20 or the support 50.

Furthermore, in the third embodiment, it is possible to make multilevel adjustment to the height of the liquid discharge head 20 simply by moving the first height adjuster 70A and the second height adjuster 70B. That is, in the third embodiment, it is possible to make multilevel adjustment to the height of the liquid discharge head 20 without preparing multiple couplers 60 having different shapes (heights D1 and D2) as in the first embodiment or the second embodiment. Thus, height adjustment can be easily performed. In particular, when work of height adjustment to the liquid discharge head needs to be performed in a narrow place, it is possible to easily make a height adjustment to the liquid discharge head by applying the configuration of the third embodiment. As a result, the burden on a worker can be reduced.

In the third embodiment, the first height adjuster 70A and the second height adjuster 70B have the recesses 71a and 71b opened in attachment directions B, respectively, as illustrated in FIG. 30. Thus, it is possible to attach the first height adjuster 70A and the second height adjuster 70B between the coupler 60 and the liquid discharge head 20 and between the coupler 60 and the support 50, respectively, without removing the fixing members 51. In addition, it is possible to move and detach the first height adjuster 70A and the second height adjuster 70B without removing the fixing members 51.

When the liquid discharge head 20 is inclined as illustrated in FIG. 45, the inclination of the liquid discharge head 20 can be adjusted (corrected) by means of the first height adjuster 70A and the second height adjuster 70B. For example, in FIG. 27, it is possible to adjust a balance between heights of the left part and right part of the liquid discharge head 20 and to correct the inclination by making movement amounts of the first height adjuster 70A and the second height adjuster 70B disposed on the right side of the liquid discharge head 20 different from movement amounts of the first height adjuster 70A and the second height adjuster 70B disposed on the left side.

### Fourth Embodiment

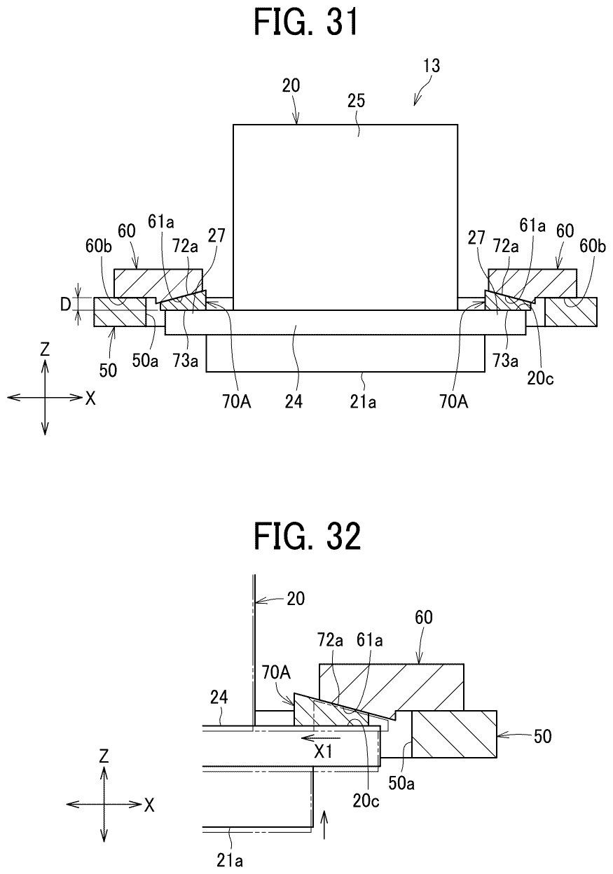

FIG. 31 is a cross-sectional view of a liquid discharge head unit according to a fourth embodiment.

In the fourth embodiment illustrated in FIG. 31, the first height adjuster 70A is provided only between the coupler 60 and the liquid discharge head 20, and is not provided between the coupler 60 and the support 50. That is, the fourth embodiment is different from the third embodiment in that the second height adjuster 70B provided in the third embodiment is omitted from the fourth embodiment.

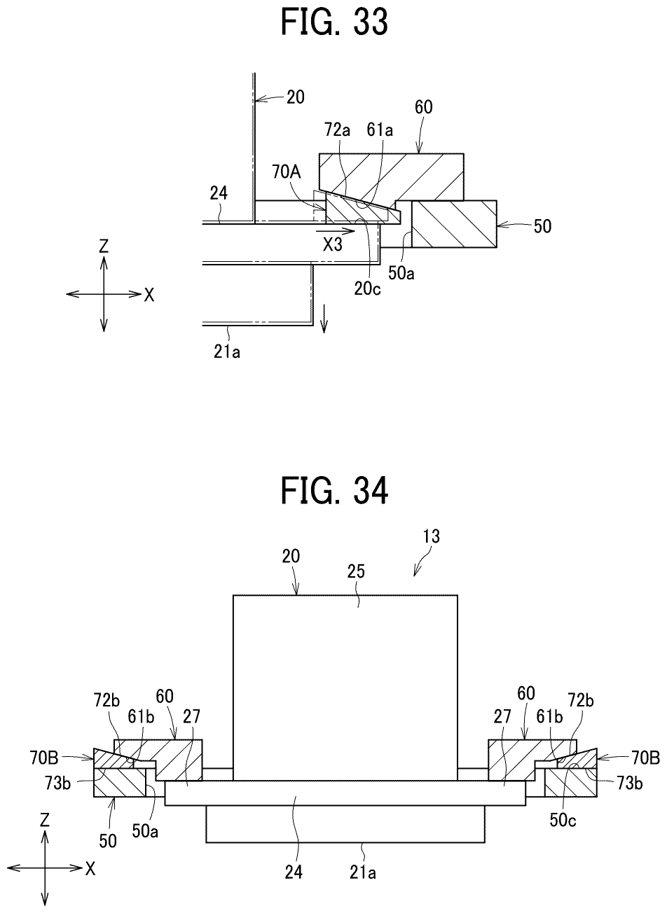

In this case, it is possible to adjust the position of the liquid discharge head 20 with respect to the support 50 in the height direction by moving the first height adjuster 70A in a direction (X1 direction in FIG. 32) in which the first height adjuster 70A moves backward with respect to the coupler 60 as illustrated in FIG. 32, or moving the first height adjuster 70A in an opposite direction, that is, a direction (X3 direction in FIG. 33) in which the first height adjuster 70A moves forward with respect to the coupler 60 as illustrated in FIG. 33. In this case, the coupler 60 may be integrated with the support 50. Even when the coupler 60 is integrated with the support 50 (that is, a case where a part of the support 50 has a contact surface in contact with the inclined surface 72a), it is possible to adjust the position of the liquid discharge head 20 in the height direction by moving the first height adjuster 70A in the direction (X1 direction in FIG. 32) in which the first height adjuster 70A moves backward with respect to the support 50, or moving the first height adjuster 70A in the direction (X3 direction in FIG. 33) in which the first height adjuster 70A moves forward with respect to the support 50.

### Fifth Embodiment

FIG. 34 is a cross-sectional view of a liquid discharge head unit according to a fifth embodiment.

In the fifth embodiment illustrated in FIG. 34, the second height adjuster 70B is provided only between the coupler 60 and the support 50, and is not provided between the coupler 60 and the liquid discharge head 20. That is, the fifth embodiment is different from the third embodiment in that the first height adjuster 70A provided in the third embodiment is omitted from the fifth embodiment.

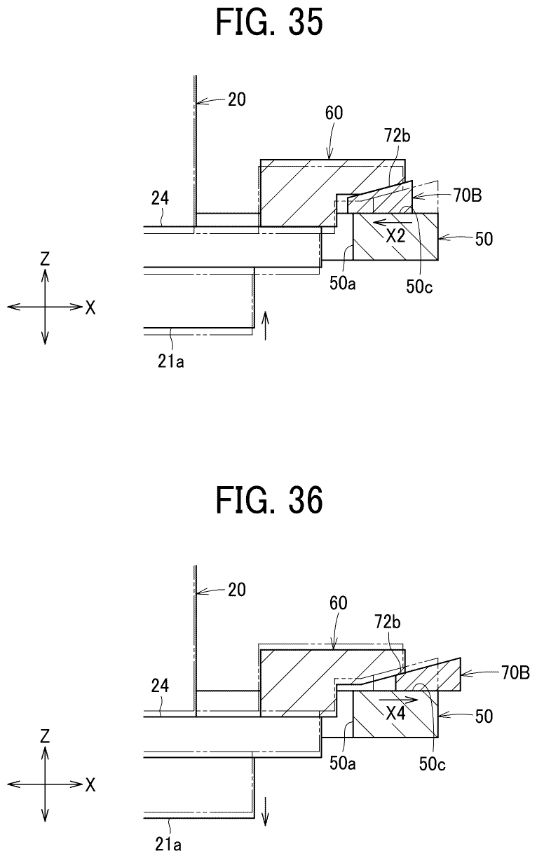

In this case, it is possible to adjust the position of the liquid discharge head 20 with respect to the support 50 in the height direction by moving the second height adjuster 70B in a direction (X2 direction in FIG. 35) in which the second height adjuster 70B moves forward with respect to the coupler 60 as illustrated in FIG. 35 or moving the second height adjuster 70B in an opposite direction, that is, a direction (X4 direction in FIG. 36) in which the second height adjuster 70B moves backward with respect to the coupler 60 as illustrated in FIG. 36. In this case, the coupler 60 may be integrated with the liquid discharge head 20. Even when the coupler 60 is integrated with the liquid discharge head 20 (that is, when a part of the liquid discharge head 20 has a contact surface in contact with the inclined surface 72b), it is possible to adjust the position of the liquid discharge head 20 in the height direction by moving the second height adjuster 70B in the direction (X2 direction in FIG. 35) in which the second height adjuster 70B moves forward with respect to the liquid discharge head 20, or moving the second height adjuster 70B in an opposite direction, that is, the direction (X4 direction in FIG. 36) in which the second height adjuster 70B moves backward with respect to the liquid discharge head 20.

It is also possible to easily adjust the height of the liquid discharge head 20 without significantly changing the shapes of the liquid discharge head 20 and the support 50, by providing either the first height adjuster 70A or the second height adjuster 70B and moving the provided first height adjuster 70A or 70B as in the fourth embodiment and the fifth embodiment described above. However, the range of height adjustable in the case of performing the height adjustment by using a single height adjuster is limited as compared with the case of performing the height adjustment by using two height adjusters. Therefore, in the case of significantly changing the height of the liquid discharge head 20, it is preferable to perform the height adjustment by using two height adjusters (the first height adjuster 70A and the second height adjuster 70B).

Note that when any one of the inclined surface 72a of the first height adjuster 70A and the second height adjuster 70B, the inclined surface 72b of the second height adjuster 70B, and the inclined surfaces 61a and 61b of the coupler 60 is an inclined surface, the height of the liquid discharge head 20 can be adjusted even when a surface facing the inclined surface is not an inclined surface. However, in this case, the area of a contact surface decreases, and the contact surface may be deformed by pressure when secured by the fixing member 51. Therefore, it is preferable to bring parallel inclined surfaces into contact with each other. When the coupler 60 of FIG. 34 is integrated with the liquid discharge head 20 or when the coupler 60 of FIG. 31 is integrated with the support 50, at least one of a first contact surface of the liquid discharge head 20 in contact with the second height adjuster 70B of FIG. 34, a second contact surface of the support 50 in contact with the first height adjuster 70A of FIG. 31, and the contact surfaces of the first height adjuster 70A and the second height adjuster 70B in contact with the first contact surface and the second contact surface, respectively, may be an inclined surface inclined with respect to the height direction. Also in this case, the first contact surface, the second contact surface, and the contact surfaces of the first height adjuster 70A and the second height adjuster 70B in contact with either the first contact surface or the second contact surface are preferably inclined surfaces parallel to each other.

### Modification of Height Adjusters

Next, modifications of the first height adjuster 70A and the second height adjuster 70B according to the present disclosure will be described. Modifications of the second height adjuster 70B will be described below as examples, but the modifications can be similarly applied to the first height adjuster 70A.

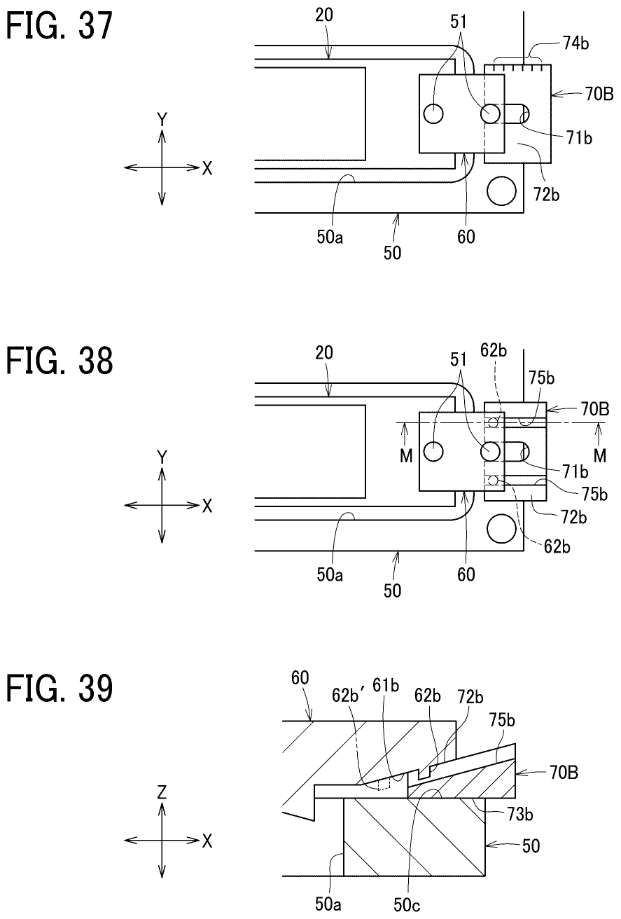

FIG. 37 is a plan view of a modification of the height adjuster.

In the modification illustrated in FIG. 37, the second height adjuster 70B has a scale 74b marked thereon. The scale 74b extends in a direction of movement (X direction) of the second height adjuster 70B. The “direction of movement” mentioned here refers to the direction of movement of the second height adjuster 70B at the time of height adjustment, and refers to, for example, the X2 direction in FIG. 28 or the X4 direction in FIG. 29.

Thus, in the modification illustrated in FIG. 37, the second height adjuster 70B has the scale 74b marked thereon, the scale 74b extending in the direction of movement of the second height adjuster 70B. Therefore, a worker can confirm the position (amount of movement) of the second height adjuster 70B with reference to the scale 74b. This facilitates accurate adjustment of the height of the liquid discharge head 20.

In this modification, the scale 74b is provided on the inclined surface 72b of the second height adjuster 70B (see FIG. 37). Meanwhile, the scale 74b may be provided at a portion other than the inclined surface 72b as long as the portion can be visually recognized by the worker.

FIG. 38 is a plan view of another modification of the height adjuster. FIG. 39 is a cross-sectional view of another modification of the height adjuster taken along line M-M in FIG. 38.

In the modification illustrated in FIGS. 38 and 39, the second height adjuster 70B has a guide 75b that is a groove-like portion extending in the direction of movement (X direction) of the second height adjuster 70B. The “direction of movement” mentioned here also refers to the direction of movement of the second height adjuster 70B at the time of height adjustment as with the “direction of movement” described above.

Furthermore, in this modification, the coupler 60 includes a slide 62b. The slide 62b is inserted into the guide 75b and relatively slidable along the guide 75b.

Thus, in the modification illustrated in FIGS. 38 and 39, the second height adjuster 70B has the guide 75b as described above, and the coupler 60 has the slide 62b slidable along the guide 75b. Therefore, when the second height adjuster 70B enters a space between the coupler 60 and the support 50 or when the second height adjuster 70B is moved for height adjustment, it is possible to prevent the second height adjuster 70B from skewing. That is, when the second height adjuster 70B enters or moves, the slide 62b relatively slides along the guide 75b. As a result, the second height adjuster 70B can be guided in a predetermined direction. Therefore, it is possible to prevent the second height adjuster 70B from skewing. Thus, the inclined surfaces 72b and 61b of the second height adjuster 70B and the coupler 60, respectively, can be brought into contact with each other in a predetermined direction. As a result, height adjustment can be performed with high accuracy.

In this modification, two sets of the guide 75b and the slide 62b are provided (see FIG. 38). Meanwhile, as long as the slide 62b does not rotate in the guide 75b, a single set of the guide 75b and the slide 62b may be provided. In addition, a second slide 62b′ (see a two-dot chain line in FIG. 39) may be provided at a position away from a single slide (first slide) 62b in the direction of movement (X direction) of the second height adjuster 70B. In this case, the second height adjuster 70B is restricted so as not to rotate, by the two slides 62b and 62b′ located away from each other. Therefore, it is possible to further enhance parallelism of the inclined surfaces 72b and 61b with each other. In the examples of FIGS. 38 and 39, the guide 75b is provided in the second height adjuster 70B, and the slide 62b is provided on the coupler 60. Meanwhile, the guide 75b and the slide 62b may be provided in an opposite manner. That is, the guide 75b may be provided in the coupler 60, and the slide 62b may be provided on the second height adjuster 70B.

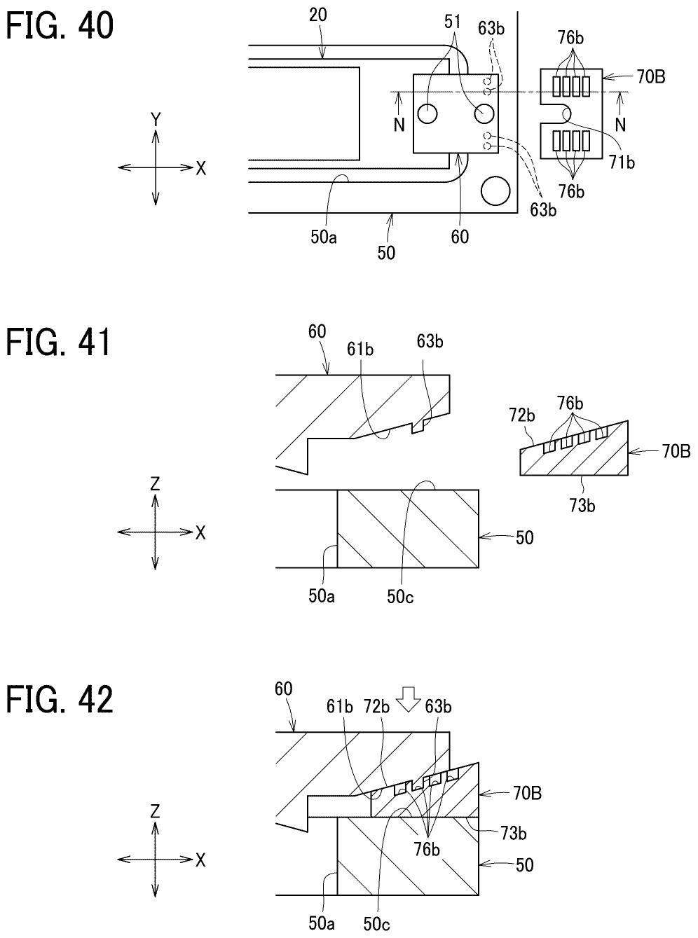

FIG. 40 is a plan view of still another modification of the height adjuster. FIG. 41 is a cross-sectional view of the still another modification of the height adjuster taken along line N-N in FIG. 40.

In the modification illustrated in FIGS. 40 and 41, the second height adjuster 70B has multiple engagement recesses 76b provided at different positions, the engagement recesses 76b being arranged in the direction of movement (X direction) of the second height adjuster 70B. The “direction of movement” mentioned here also refers to the direction of movement of the second height adjuster 70B at the time of height adjustment as with the “direction of movement” described above.

In addition, in this modification, the coupler 60 has an engagement protrusion 63b that can be inserted into and engaged with a single engagement recess 76b freely selected from among the multiple engagement recesses 76b.

Thus, in the modification illustrated in FIGS. 40 and 41, the second height adjuster 70B has the multiple engagement recesses 76b as described above, and the coupler 60 has the engagement protrusion 63b that can be engaged with one of the multiple engagement recesses 76b. As a result, it is possible to prevent movement of the second height adjuster 70B when the second height adjuster 70B is interposed between the coupler 60 and the support 50 as illustrated in FIG. 42. That is, the engagement protrusion 63b is engaged with one of the engagement recesses 76b when the second height adjuster 70B is interposed between the coupler 60 and the support 50 and the inclined surface 72b of the second height adjuster 70B and the inclined surface 61b of the coupler 60 are in contact with each other. As a result, movement of the second height adjuster 70B can be prevented. Thus, the second height adjuster 70B can be prevented from being pushed out from between the coupler 60 and the support 50. That is, when the coupler 60 is secured by the fixing members 51 when the second height adjuster 70B is interposed between the coupler 60 and the support 50, a force causing the second height adjuster 70B to be pushed out to the right side in FIG. 42 is generated by the securing force of the fixing members 51. However, since the engagement protrusion 63b and the engagement recess 76b are engaged with each other at this time, it is possible to prevent the second height adjuster 70B from being pushed out to the right side or prevent positional shift of the second height adjuster 70B. As a result, since the second height adjuster 70B can be held at a predetermined position, it is possible to prevent a variation in the height of the liquid discharge head 20 due to a positional shift of the second height adjuster 70B. It is thus possible to hold the liquid discharge head 20 at a desired height. Furthermore, it is possible to change the height of the liquid discharge head 20 by changing a portion to be engaged (the engagement recess 76b to be engaged) with the engagement protrusion 63b to another portion (another engagement recess 76b).

Also in this modification, the engagement protrusion 63b and the engagement recess 76b may be provided in an opposite manner. That is, the engagement protrusion 63b may be provided on the second height adjuster 70B, and the engagement recess 76b may be provided in the coupler 60.

The embodiments and the modifications have been described above. Meanwhile, the present disclosure is not limited to the above-described embodiments and modifications, and it is possible to change design as appropriate without departing from the scope of the present disclosure. Furthermore, the above-described modifications may be appropriately combined and applied. For example, the modification such as the scale 74b of FIG. 37 may be applied in combination with the modification such as the guide 75b of FIG. 38 or the modification such as the multiple engagement recesses 76b of FIG. 40.

According to the configurations of the third to fifth embodiments, the heights of the multiple liquid discharge heads 20 can be separately adjusted.

For example, when the support 50 that supports the multiple liquid discharge heads 20A and 20B is disposed parallel to the sheet S conveyed in the horizontal direction (disposed horizontally) as illustrated in FIG. 21, it is possible to keep the nozzle faces at a constant distance (equal distance) from the sheet S by making the liquid discharge heads 20A and 20B arranged on the upstream side and the downstream side in the sheet conveyance direction E, respectively, equal in height by the first height adjuster 70A and the second height adjuster 70B.

Meanwhile, when the sheet S is conveyed in an arc-like manner along the conveying drum 10 as illustrated in FIG. 22, it is possible to keep the nozzle faces at a constant distance (equal distance) from the sheet S by making the heights of the liquid discharge heads 20A and 20B arranged on the upstream side and the downstream side in the sheet conveyance direction E, respectively, different from each other by the first height adjuster 70A and the second height adjuster 70B.

Thus, also in the configurations of the third to fifth embodiments, the heights of the multiple liquid discharge heads can be separately adjusted. It is thus possible to keep the respective nozzle faces of the liquid discharge heads at a constant distance from the sheet depending on sheet conveyance paths.

The case where the present disclosure is applied to a liquid discharge head unit mounted on an image forming apparatus has been described as an example in each of the above-described embodiments and modifications. Meanwhile, the present disclosure is also applicable to a liquid discharge head unit mounted on a liquid discharge apparatus other than image forming apparatuses. For example, the following electrode manufacturing apparatus can be cited as an example of another liquid discharge apparatus to which the present disclosure can be applied.

### Electrode Manufacturing Apparatus

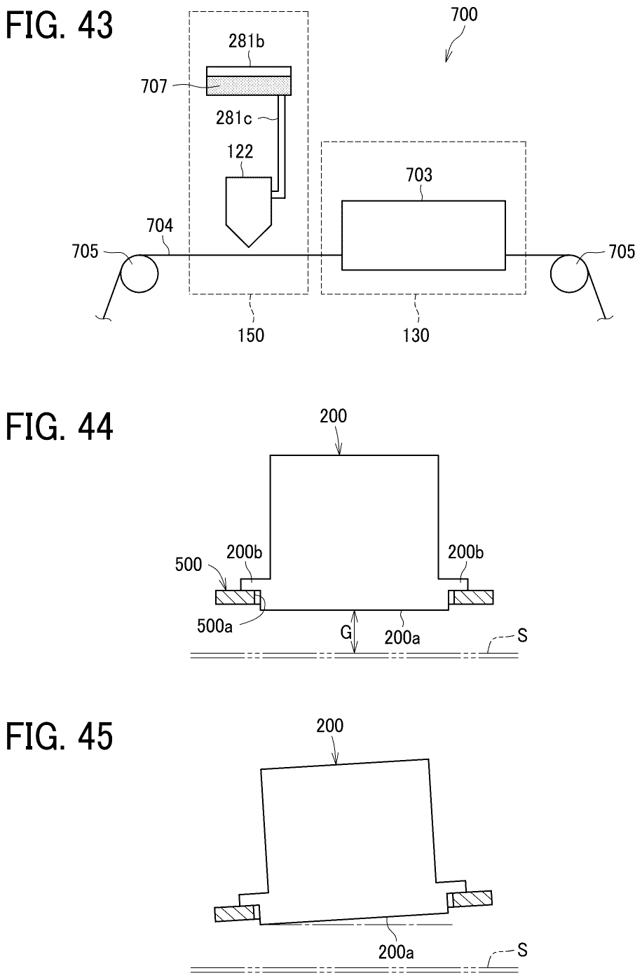

FIG. 43 is a diagram illustrating an exemplary electrode manufacturing apparatus to which the present disclosure can be applied.

An electrode manufacturing apparatus 700 illustrated in FIG. 43 is an apparatus that discharges a liquid composition containing an electrode material onto a target object 704 by means of a liquid discharge head 122 to produce an electrode on the target object 704.

More specifically, as illustrated in FIG. 43, the electrode manufacturing apparatus 700 includes a discharge process unit 150 and a heating process unit 130. The discharge process unit 150 discharges a liquid composition containing an electrode material onto the target object 704 to form a liquid composition layer. The heating process unit 130 heats the liquid composition layer to form an electrode mixture layer. Examples of the target object 704 include an electrode substrate (current collector), an active material layer, and a layer containing a solid electrode material. The target object 704 may be an electrode mixture layer containing an active material on an electrode substrate (current collector). The electrode mixture layer can be suitably used as, for example, a part of the configuration of an electrochemical element. The configuration of the electrochemical element other than the electrode mixture layer is not particularly limited, and a known configuration can be appropriately selected. For example, as a configuration other than the electrode mixture layer, the electrochemical element may include a positive electrode, a negative electrode, and a separator.

The electrode manufacturing apparatus 700 also includes a conveyor 705 that conveys the target object 704. The conveyor 705 conveys the target object 704 to the discharge process unit 150 and the heating process unit 130 in this order at a preset speed. The discharge process unit 150 includes the liquid discharge head 122, a storage container 281b, and a supply tube 281c. The liquid discharge head 122 implements an application process of applying the liquid composition onto the target object 704. The storage container 281b stores a liquid composition 707. The supply tube 281c supplies the liquid composition 707 stored in the storage container 281b to the liquid discharge head 122.

In the discharge process unit 150, the liquid composition 707 is discharged from the liquid discharge head 122 to apply the liquid composition 707 onto the target object 704. As a result, a liquid composition layer is formed as a thin film. In addition, the discharge process unit 150 may perform a step of directly discharging the liquid composition 707 or a step of indirectly discharging the liquid composition 707 as long as a layer having an electrode material can be formed on the target object 704.

The storage container 281b and the supply tube 281c can be freely selected as long as the liquid composition 707 can be stably stored and supplied to the liquid discharge head 122. The storage container 281b may be integrated with the electrode manufacturing apparatus 700, or may be detachable from the electrode manufacturing apparatus 700.

The heating process unit 130 performs a solvent removal process of heating and removing solvent remaining in the liquid composition layer. Specifically, the solvent remaining in the liquid composition layer is heated and dried by a heating device 703 of the heating process unit 130, and thus the solvent is removed from the liquid composition layer. Thus, the electrode mixture layer is formed. The solvent removal process may be performed in the heating process unit 130 under reduced pressure.

The heating device 703 is not particularly limited and may be appropriately selected depending on the intended purpose.

For example, the heating device 703 may be a substrate heater, an infrared (IR) heater, or a hot air heater.

The heating device 703 may be a combination of at least two of the substrate heater, the IR heater, and the hot air heater. A heating temperature and heating time can be appropriately selected according to a boiling point of the solvent contained in the liquid composition 707 or the thickness of a formed film.

Also in the liquid discharge head unit (unit including the liquid discharge head 122) to be mounted on the electrode manufacturing apparatus 700 as described above, application of the configurations of the present disclosure makes it possible to easily adjust the height of the liquid discharge head 122 without significantly changing the shape of the liquid discharge head 122 and the shape of the support that supports the liquid discharge head 122.

The liquid discharge apparatus according to the present disclosure may be not only the image forming apparatus and the electrode manufacturing apparatus but also a three-dimensional fabrication apparatus that discharges a modeling liquid to a powder layer in which powder is formed into a layer so as to model a three-dimensional fabrication object.

The liquid discharge apparatus according to the present disclosure is not limited to an apparatus that discharges liquid to an object to which liquid can adhere, and may be an apparatus that discharges liquid into air or liquid. The “liquid discharge apparatus” may include a unit regarding feeding, conveyance, and sheet ejection of an object to which liquid can adhere, a pretreatment apparatus, and a post-treatment apparatus.

Therefore, the liquid to be discharged by the liquid discharge apparatus according to the present disclosure is not limited to ink for forming a meaningful image such as a character or a figure, and may be a treatment liquid to be applied to a surface of a sheet for the purpose of reforming the surface of the sheet, a modeling liquid for modeling a three-dimensional image, or the like in addition to ink for forming a pattern or the like that does not have any meaning. Liquid to be discharged from the liquid discharge head is not limited to a particular liquid as long as the liquid has a viscosity or surface tension that enables the liquid to be discharged from the liquid discharge head. Meanwhile, preferably, the viscosity of the liquid is not greater than 30 mPa's at ordinary temperature under ordinary pressure or by heating or cooling. Examples of the liquid include a solution, a suspension, and an emulsion including, for example, a solvent, such as water or an organic solvent, a colorant, such as dye or pigment, a functionality imparting material, such as a polymerizable compound, a resin, or a surfactant, a biocompatible material, such as deoxyribonucleic acid (DNA), amino acid, protein, or calcium, or an edible material, such as a natural colorant. Such a solution, a suspension, and an emulsion can be used for, e.g., inkjet ink, surface treatment solution, a liquid for forming components of an electronic element or a light-emitting element or a resist pattern of an electronic circuit, or a material solution for three-dimensional fabrication.

The object to which liquid can adhere to be used in the present disclosure includes an object to which liquid can adhere at least temporarily, such as an object to which liquid adheres and sticks and an object to be permeated by liquid that adheres thereto. Examples of the “object to which liquid can adhere” include media on which data are to be recorded, such as a paper sheet, a recording paper, a recording sheet of paper, a film, and cloth, electronic components, such as an electronic substrate and a piezoelectric element, and media, such as a powder layer, an organ model, and a testing cell. The “object to which liquid can adhere” includes any material to which liquid can adhere, unless particularly limited.

Examples of the material of the “object to which liquid can adhere” also include any materials on which liquid can adhere even temporarily, such as paper, thread, fiber, fabric, leather, metal, plastic, glass, wood, and ceramic.

A liquid discharge head unit includes: a liquid discharge head to discharge a liquid in a discharge direction; a support supporting the liquid discharge head; and a coupler to couple the liquid discharge head to the support. The support has an opening into which at least a discharge side of the liquid discharge head is insertable in the discharge direction, the coupler includes: a first contact contacting the liquid discharge head inserted into the opening; and a second contact contacting the support, and the first contact and the second contact are disposed at different positions in the discharge direction.

Both the first contact and the second contact of the coupler face the discharge direction. The liquid discharge head unit further includes: a height adjuster interposed: between the first contact of the coupler and the liquid discharge head in the discharge direction; or between the second contact of the coupler and the support in the discharge direction.

The liquid discharge head further includes: a first coupler including the coupler; and a second coupler including the coupler. The first coupler is at one end of the liquid discharge head in a longitudinal direction, of the liquid discharge head, orthogonal to the discharge direction, the second coupler is at the other end opposite to the one end of the liquid discharge head in the longitudinal direction, the first coupler has a first distance between the first contact and the second contact in the discharge direction, and the second coupler has a second distance different from the first distance between the first contact and the second contact in the discharge direction.

The liquid discharge head unit further includes: a first coupler including the coupler; a second coupler including the coupler; and a height adjuster. The first coupler is at one end of the liquid discharge head in a longitudinal direction, of the liquid discharge head, orthogonal to the discharge direction, the second coupler is at the other end opposite to the one end of the liquid discharge head in the longitudinal direction, and the height adjuster is interposed between at least one of: the first contact of the first coupler and the liquid discharge head in the discharge direction; or the second contact of the second coupler and the support in the discharge direction.

The liquid discharge head unit further includes: a first discharge head including the liquid discharge head; a second discharge head including the liquid discharge head; a first coupler coupling the first discharge head and the support; and a second coupler coupling the second discharge head and the support. Each of the first discharge head and the second discharge head discharges the liquid onto a sheet conveyed in a conveyance direction orthogonal to the discharge direction, the first discharge head is disposed upstream from the second discharge head in the conveyance direction, the first coupler of the first discharge head has a first distance between the first contact and the second contact in the discharge direction, and the second coupler of the second discharge head has a second distance different from the first distance between the first contact and the second contact in the discharge direction.

The liquid discharge head unit further includes: a first discharge head including the liquid discharge head; a second discharge head including the liquid discharge head; a first coupler coupling the first discharge head and the support; and a second coupler coupling the second discharge head and the support; and a height adjuster. Each of the first discharge head and the second discharge head discharges the liquid onto a sheet conveyed in a conveyance direction orthogonal to the discharge direction, the first discharge head is disposed upstream from the second discharge head in the conveyance direction, and the height adjuster is interposed between at least one of: the first contact of the first coupler and the first discharge head in the discharge direction; or the second contact of the second coupler and the support in the discharge direction. The first contact is in contact with a surface of the liquid discharge head, the surface facing a direction opposite to the discharge direction. The first contact is in contact with a surface of the liquid discharge head, the surface facing the discharge direction.

A liquid discharge head unit includes: a liquid discharge head having a nozzle face having nozzles to discharge a liquid in a discharge direction; a support supporting the liquid discharge head; a coupler to couple the liquid discharge head to the support; and a height adjuster. The support has an opening into which at least a discharge side of the liquid discharge head is insertable in the discharge direction, the height adjuster has a first inclined surface inclined relative to the nozzle face, the height adjuster is interposed between at least one of: the coupler and the liquid discharge head in the discharge direction; or the coupler and the support in the discharge direction, the coupler has a second inclined surface contacting the first inclined surface of the height adjuster, and the height adjuster is movable in a longitudinal direction, orthogonal to the discharge direction, parallel to the nozzle face to adjust a height of the liquid discharge head.

The liquid discharge head unit further includes: a fixing member fixing at least one of the liquid discharge head or the support to the coupler, and the height adjuster has a recess recessed in the longitudinal direction. The height adjuster has a recess recessed in an attachment direction of the height adjuster attached between at least one of: the coupler and the liquid discharge head; or the coupler and the support. The height adjuster has a scale in the longitudinal direction. One of the height adjuster and the coupler includes a guide extending in the longitudinal direction, and another of the height adjuster and the coupler includes a slide slidable along the guide in the longitudinal direction. One of the height adjuster and the coupler has multiple engagement recesses disposed at different positions in the longitudinal direction, and another of the height adjuster and the coupler has an engagement protrusion to be selectively inserted into and engaged with one of the multiple engagement recesses.

A liquid discharge head unit includes: a liquid discharge head having a nozzle face having nozzles to discharge a liquid in a discharge direction; a support supporting the liquid discharge head; and a height adjuster disposed between the liquid discharge head and the support. The support has an opening into which at least a discharge side of the liquid discharge head is insertable in the discharge direction, at least one of the liquid discharge head and the support has a first inclined surface inclined relative to the nozzle face, the height adjuster has a second inclined surface in contact with the second inclined surface of the at least one of the liquid discharge head and the support, and the height adjuster is movable in a longitudinal direction, orthogonal to the discharge direction and intersecting the second inclined surface.

The second inclined surface of the height adjuster is parallel to the first inclined surface of the at least one of the liquid discharge head and the support. A liquid discharge apparatus includes: the liquid discharge head unit; and a conveyor to convey a sheet in a conveyance direction to the liquid discharge head unit.

The liquid discharge head includes a flange extending outside the liquid discharge head in a longitudinal direction, of the liquid discharge head, orthogonal to the discharge direction, the first contact of the coupler contacts an upper face of the flange of the liquid discharge head, the second contact of the coupler contacts an upper face of the support, and the coupler couples the liquid discharge head to the support to hang the liquid discharge head from the support. According to the present disclosure, it is possible to adjust the height of a liquid discharge head without significantly changing the shapes of the liquid discharge head and a support.

To summarize the aspects described above, the present disclosure includes at least the following aspects.

### Aspect 1

According to Aspect 1, a liquid discharge head unit includes: a liquid discharge head that discharges liquid; a support that supports the liquid discharge head; and a coupler to couple the liquid discharge head to the support, wherein the support has an opening into which the liquid discharge head is inserted without coming into contact with the support, the coupler includes a first contact and a second contact, the first contact coming into contact with the liquid discharge head in a state of being inserted into the opening, the second contact coming into contact with the support, and the first contact and the second contact are disposed at different positions in a height direction that is a direction in which the liquid discharge head is inserted into the opening.

### Aspect 2

According to Aspect 2, in the liquid discharge head unit of Aspect 1, the first contact and the second contact are disposed in such a way as to face an identical direction.

### Aspect 3

According to Aspect 3, the liquid discharge head unit of Aspect 1 or 2 further includes: a height adjuster interposed between the first contact and the liquid discharge head or between the second contact and the support.

### Aspect 4

According to Aspect 4, in the liquid discharge head unit of any one of Aspects 1 to 3, the coupler is disposed at each of opposite ends of the liquid discharge head, and a distance between the first contact and the second contact in the height direction differs between the coupler disposed at one of the opposite ends of the liquid discharge head and the coupler disposed at another of the opposite ends of the liquid discharge head.

### Aspect 5

According to Aspect 5, in the liquid discharge head unit of any one of Aspects 1 to 4, the coupler is disposed at each of opposite ends of the liquid discharge head, and a height adjuster is interposed at least between the liquid discharge head and the first contact of the coupler disposed at one of the opposite ends of the liquid discharge head, or between the support and the second contact of the coupler disposed at another of the opposite ends of the liquid discharge head.

### Aspect 6

According to Aspect 6, in the liquid discharge head unit of any one of Aspects 1 to 5, the liquid discharge head includes multiple liquid discharge heads arranged side by side in a sheet conveyance direction in which a sheet is conveyed, and a distance between the first contact and the second contact in the height direction differs between the coupler disposed on an upstream side in the sheet conveyance direction and the coupler disposed on a downstream side in the sheet conveyance direction.

### Aspect 7

According to Aspect 7, in the liquid discharge head unit of any one of Aspects 1 to 6, the liquid discharge head includes multiple liquid discharge heads arranged side by side in a sheet conveyance direction in which a sheet is conveyed, and a height adjuster is interposed at least between the liquid discharge head and the first contact of one of the coupler disposed on an upstream side in the sheet conveyance direction and the coupler disposed on a downstream side in the sheet conveyance direction, or between the support and the second contact of another of the coupler disposed on the upstream side in the sheet conveyance direction and the coupler disposed on the downstream side in the sheet conveyance direction.

### Aspect 8

According to Aspect 8, in the liquid discharge head unit of any one of Aspects 1 to 7, the first contact is in contact with a surface of the liquid discharge head, the surface facing a direction opposite to a liquid discharge direction.

### Aspect 9

According to Aspect 9, in the liquid discharge head unit of any one of Aspects 1 to 7, the first contact is in contact with a surface of the liquid discharge head, the surface facing a liquid discharge direction.

### Aspect 10

According to Aspect 10, a liquid discharge head unit includes: a liquid discharge head that discharges liquid; a support that supports the liquid discharge head, the support having an opening into which the liquid discharge head is inserted without coming into contact with the support; a coupler to couple the liquid discharge head to the support; and a height adjuster interposed at least between the coupler and the liquid discharge head or between the coupler and the support in a height direction that is a direction in which the liquid discharge head is inserted into the opening, wherein a contact surface of the coupler and a contact surface of the height adjuster, the contact surfaces being in contact with each other, are inclined surfaces inclined with respect to a contact surface of the height adjuster in contact with at least one of the liquid discharge head or the support, and the height adjuster is movable in a direction intersecting the inclined surface of the height adjuster.

### Aspect 11

According to Aspect 11, the liquid discharge head unit of Aspect 10 further includes: a fixing member that secures at least one of the liquid discharge head or the support to the coupler, wherein the height adjuster has a recess that avoids interference with the fixing member.

### Aspect 12

According to Aspect 12, in the liquid discharge head unit of Aspect 11, the recess opens in an attachment direction in which the height adjuster is attached to at least one of a portion between the coupler and the liquid discharge head or a portion between the coupler and the support.

### Aspect 13

According to Aspect 13, in the liquid discharge head unit of any one of Aspects 10 to 12, the height adjuster has a scale marked thereon, the scale extending in a direction of movement of the height adjuster.

### Aspect 14

According to Aspect 14, in the liquid discharge head unit of any one of Aspects 10 to 13, one of the height adjuster and the coupler includes a guide extending in a direction of movement of the height adjuster, and another of the height adjuster and the coupler includes a slide that is relatively slidable along the guide.

### Aspect 15

According to Aspect 15, in the liquid discharge head unit of any one of Aspects 10 to 13, one of the height adjuster and the coupler has multiple engagement recesses provided at different positions, the engagement recesses being arranged in a direction of movement of the height adjuster, and another of the height adjuster and the coupler has an engagement protrusion to be selectively inserted into and engaged with one of the multiple engagement recesses when the inclined surfaces of the height adjuster and the coupler are in contact with each other.

### Aspect 16

According to Aspect 16, a liquid discharge head unit includes: a liquid discharge head that discharges liquid; a support that supports the liquid discharge head, the support having an opening into which the liquid discharge head is inserted without coming into contact with the support; a height adjuster disposed between the liquid discharge head and the support; and at least one of a first contact surface of the liquid discharge head or a second contact surface of the support, the first contact surface being in contact with the height adjuster, the second contact surface being in contact with the height adjuster, wherein at least one of the first contact surface, the second contact surface, or a contact surface of the height adjuster in contact with the at least one of the first contact surface or the second contact surface is an inclined surface inclined with respect to a height direction that is a direction in which the liquid discharge head is inserted into the opening, and the height adjuster is movable in a direction intersecting the inclined surface of the height adjuster.

### Aspect 17

According to Aspect 17, in the liquid discharge head unit of Aspect 16, at least one of the first contact surface or the second contact surface is an inclined surface inclined with respect to the height direction, and the contact surface of the height adjuster in contact with the at least one of the first contact surface or the second contact surface is a surface parallel to the inclined surface.

Aspect 18

According to Aspect 18, a liquid discharge apparatus includes the liquid discharge head unit of any one of Aspects 1 to 17.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head unit comprising:
a liquid discharge head to discharge a liquid in a discharge direction;
a support supporting the liquid discharge head; and
a coupler to couple the liquid discharge head to the support,
wherein the support has an opening into which at least a discharge side of the liquid discharge head is insertable in the discharge direction,
the coupler includes:
a first contact contacting the liquid discharge head inserted into the opening; and
a second contact contacting the support, and
the first contact and the second contact are disposed at different positions in the discharge direction.

2. The liquid discharge head unit according to claim 1,
wherein both the first contact and the second contact of the coupler face the discharge direction.

3. The liquid discharge head unit according to claim 1, further comprising:
a height adjuster interposed:
between the first contact of the coupler and the liquid discharge head in the discharge direction; or
between the second contact of the coupler and the support in the discharge direction.

4. The liquid discharge head unit according to claim 1, further comprising:
a first coupler including the coupler; and
a second coupler including the coupler,
wherein the first coupler is at one end of the liquid discharge head in a longitudinal direction, of the liquid discharge head, orthogonal to the discharge direction,
the second coupler is at the other end opposite to the one end of the liquid discharge head in the longitudinal direction,
the first coupler has a first distance between the first contact and the second contact in the discharge direction, and
the second coupler has a second distance different from the first distance between the first contact and the second contact in the discharge direction.

5. The liquid discharge head unit according to claim 1, further comprising:
a first coupler including the coupler;
a second coupler including the coupler; and
a height adjuster,
wherein the first coupler is at one end of the liquid discharge head in a longitudinal direction, of the liquid discharge head, orthogonal to the discharge direction,
the second coupler is at the other end opposite to the one end of the liquid discharge head in the longitudinal direction, and
the height adjuster is interposed between at least one of:
the first contact of the first coupler and the liquid discharge head in the discharge direction; or
the second contact of the second coupler and the support in the discharge direction.

6. The liquid discharge head unit according to claim 1, further comprising:
a first discharge head including the liquid discharge head;
a second discharge head including the liquid discharge head;
a first coupler coupling the first discharge head and the support; and
a second coupler coupling the second discharge head and the support,
wherein each of the first discharge head and the second discharge head discharges the liquid onto a sheet conveyed in a conveyance direction orthogonal to the discharge direction,
the first discharge head is disposed upstream from the second discharge head in the conveyance direction,
the first coupler of the first discharge head has a first distance between the first contact and the second contact in the discharge direction, and
the second coupler of the second discharge head has a second distance different from the first distance between the first contact and the second contact in the discharge direction.

7. The liquid discharge head unit according to claim 1, further comprising:
a first discharge head including the liquid discharge head;
a second discharge head including the liquid discharge head;
a first coupler coupling the first discharge head and the support; and
a second coupler coupling the second discharge head and the support; and
a height adjuster,
wherein each of the first discharge head and the second discharge head discharges the liquid onto a sheet conveyed in a conveyance direction orthogonal to the discharge direction,
the first discharge head is disposed upstream from the second discharge head in the conveyance direction, and
the height adjuster is interposed between at least one of:
the first contact of the first coupler and the first discharge head in the discharge direction; or
the second contact of the second coupler and the support in the discharge direction.

8. The liquid discharge head unit according to claim 1,
wherein the first contact is in contact with a surface of the liquid discharge head, the surface facing a direction opposite to the discharge direction.

9. The liquid discharge head unit according to claim 1,
wherein the first contact is in contact with a surface of the liquid discharge head, the surface facing the discharge direction.

10. A liquid discharge head unit comprising:
a liquid discharge head having a nozzle face having nozzles to discharge a liquid in a discharge direction;
a support supporting the liquid discharge head;
a coupler to couple the liquid discharge head to the support; and
a height adjuster,
wherein the support has an opening into which at least a discharge side of the liquid discharge head is insertable in the discharge direction,
the height adjuster has a first inclined surface inclined relative to the nozzle face,
the height adjuster is interposed between at least one of:
the coupler and the liquid discharge head in the discharge direction; or
the coupler and the support in the discharge direction,
the coupler has a second inclined surface contacting the first inclined surface of the height adjuster, and
the height adjuster is movable in a longitudinal direction, orthogonal to the discharge direction, parallel to the nozzle face to adjust a height of the liquid discharge head.

11. The liquid discharge head unit according to claim 10, further comprising:
a fixing member fixing at least one of the liquid discharge head or the support to the coupler,
wherein the height adjuster has a recess recessed in the longitudinal direction.

12. The liquid discharge head unit according to claim 11,
wherein the height adjuster has a recess recessed in an attachment direction of the height adjuster attached between at least one of:
the coupler and the liquid discharge head; or
the coupler and the support.

13. The liquid discharge head unit according to claim 10,
wherein the height adjuster has a scale in the longitudinal direction.

14. The liquid discharge head unit according to claim 10,
wherein one of the height adjuster and the coupler includes a guide extending in the longitudinal direction, and
another of the height adjuster and the coupler includes a slide slidable along the guide in the longitudinal direction.

15. The liquid discharge head unit according to claim 10,
wherein one of the height adjuster and the coupler has multiple engagement recesses disposed at different positions in the longitudinal direction, and
another of the height adjuster and the coupler has an engagement protrusion to be selectively inserted into and engaged with one of the multiple engagement recesses.

16. A liquid discharge head unit comprising:
a liquid discharge head having a nozzle face having nozzles to discharge a liquid in a discharge direction;
a support supporting the liquid discharge head; and
a height adjuster disposed between the liquid discharge head and the support,
wherein the support has an opening into which at least a discharge side of the liquid discharge head is insertable in the discharge direction,
at least one of the liquid discharge head and the support has a first inclined surface inclined relative to the nozzle face,
the height adjuster has a second inclined surface in contact with the second inclined surface of the at least one of the liquid discharge head and the support, and
the height adjuster is movable in a longitudinal direction, orthogonal to the discharge direction and intersecting the second inclined surface.

17. The liquid discharge head unit according to claim 16,
wherein the second inclined surface of the height adjuster is parallel to the first inclined surface of the at least one of the liquid discharge head and the support.

18. A liquid discharge apparatus comprising:
the liquid discharge head unit according to claim 1; and
a conveyor to convey a sheet in a conveyance direction to the liquid discharge head unit.

19. The liquid discharge head unit according to claim 1,
wherein the liquid discharge head includes a flange extending outside the liquid discharge head in a longitudinal direction, of the liquid discharge head, orthogonal to the discharge direction,
the first contact of the coupler contacts an upper face of the flange of the liquid discharge head,
the second contact of the coupler contacts an upper face of the support, and
the coupler couples the liquid discharge head to the support to hang the liquid discharge head from the support.
